(19) United States
(12) Patent Application Publication
(10) Pub. No.: US 2008/0037789 A1
(43) Pub. Date: Feb. 14, 2008

(54) Document Processing Device, Document Reading Device, and Document Processing Method

(75) Inventor: Daisuke Motohashi, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima (JP)

(21) Appl. No.: 11/630,442

(22) PCT Filed: Jun. 21, 2005
(86) PCT No.: PCT/JP05/11322

§ 371 Date: Dec. 22, 2006

(30) Foreign Application Priority Data
Jun. 25, 2004 (JP) 2004-187914

(51) Int. Cl. H04L 9/06; H04L 9/32

(52) U.S. Cl. 380/277; 713/193

(57) ABSTRACT

Document management that offers improved ease-of-use is realized.

A document storage unit 240 stores a document file to be encrypted. A document display unit 210 displays the contents of the document file on a screen. An encryption region specifying unit 214 allows a document editor to input data that specifies the region of the encryption target data in the document file displayed on the screen. A public key storage unit 242 stores public key data that corresponds to private key data held by document checkers. A checker level setting unit 216 allows the document editor to input data that specifies the access level for the encryption target data. A key search unit 232 detects the public key data that corresponds to the private key data of the document checker thus specified. An encryption processing unit 234 encrypts the encryption target data according to the public key encryption method using the public key data thus detected.

### TECHNICAL FIELD

The present invention relates to a document file managing technique, and particularly to a document file encryption technique using a public key encryption method.

### BACKGROUND ART

In recent years, replacement of electronic information via a network is becoming widespread due to the spread of computers and the advance of network techniques. This is promoting replacement of paper-based office operations by network-based operations.

Examples of such office operations include the consensus-building process which asks multiple staff members for their approval for a proposal. With the consensus-building system which has been becoming spread in recent years, a document file is circulated among multiple terminals via a network. Such a system allows each consensus-building staff member who can access the document to input his/her decision whether the proposal is to be approved or rejected. Such a consensus-building system improves the decision speed in increments of organizations, as well as promoting paperless operations.

[Patent Document 1]

Japanese Patent Application Laid-open No. 2001-290804

### DISCLOSURE OF INVENTION

### Problems to be Solved by the Invention

In general, the document file for the consensus-building process is circulated among the consensus-building staff members in order from lower to higher authority. In this process, it is not always necessary that each staff member should check all the items in the consensus-building document. In many cases, it is sufficient for each stuff member to check only the items which can be decided in accordance with his/her own authority. The reasons are as follows. First, let us consider an arrangement in which each staff member must check all the items in the consensus-building document. Such an arrangement places an extra load on each staff member, resulting in reduction in the efficiency of the consensus-building process. On the other hand, in some cases, it is desirable that access of a part of the items in the document file is restricted to particular stuff members. Examples of such cases include a case in which access of a part of the items in the document file should be restricted to executive personnel. Also, recently, there is increased awareness of the importance of information management. Accordingly, situations requiring limited information disclosure for each checker according to his/her own authority to access the document is not unique to the consensus-building process.

In general, a “password” method is conceivable as a method for restricting the access of the document file. With such an arrangement, particular data in the document file, which is to be protected such that the access is restricted, is protected using a password. As a result, access of the particular data is restricted to staff members having the password. Such an arrangement provides a multi-level structure of disclosure of the information between a group having the password and a group having no password.

However, password authentication often reduces ease-of-use of the system. Let us consider a case in which a document editor has set a password for the entire document file or a part of the data. In this case, the document editor must supply a password to the checkers who are to be permitted to access the data protected by the password. Furthermore, these checkers need to hold the password thus received. Such a method reduces the ease-of-use of the consensus-building system for both the document editor and the document checkers. Also, the protecting system using passwords is readily cracked by illegal readout of the password or leakage of the password. That is to say, it can be said that such an arrangement does not provide a sufficiently reliable protecting system.

It is an object of the present invention to provide a efficient document file managing technique by applying an encryption method that provides improved ease-of-use.

### Means for Solving the Problems

A document processing apparatus according to an aspect of the present invention comprises: a document storage unit for storing a document file which is to be encrypted; a display processing unit for displaying the contents of the document file on a screen; a region specifying input unit for allowing a document editor to specify the region of encryption target data in the document file displayed on the screen; a public key storage unit for storing public key data that corresponds to private key data held by each document checker; a checker specifying input unit for allowing the document editor to specify the document checkers who are to be permitted to access the encrypted target data; a public key detection unit for detecting public key data that corresponds to the private key data of the document checkers thus specified; an encryption processing unit for creating encrypted data by encrypting the encryption target data according to a public key encryption method using the public key data thus detected; and an encrypted document creating unit for creating an encrypted document file by replacing the encryption target data thus specified in the document file with the encrypted data thus created.

The term “document file” as used here may represent digital data including character strings, images, audio data, etc. Accordingly, the data to be encrypted is not restricted to character strings. Rather, examples of such encryption target data include image data, audio data, and character strings indicating links to other data. The document file may be described in a markup language such as HTML (Hyper Text Markup Language), XML (eXtensible Markup Language), SGML (Standard Generalized Mark-up Language), etc. In particular, in recent years, XML has been attracting attention as a format that allows the user to share data with other users via a network. This promotes the development of various applications for creating, displaying, and editing XML documents. The term “document editor” as used here is not restricted to the proposer of a consensus-building process. Rather, the document editor means a user who makes encryption settings for a document file. The private key data may be unique data for each document checker. Also, the private key data may be shared among multiple document checkers. For example, the private key data and the corresponding public key data may be set for each position such as “section head”, “department head”, etc. Also, the private key data and the corresponding public key data may be set for each department such as “development department”, “accounting department”, etc.

Such an arrangement substantially requires a document editor to input only the data that indicates which data is to be encrypted, and the data that indicates who is to be a checker, according to the decision of the document editor. In other words, such an apparatus provides security without the need for the document editor to perform particular input operation necessary to maintain the security such as input of a password. Also, such an arrangement allows the document checker to decrypt the document without the need to perform particular input operations. The reason is that the encryption process and the decryption process according to the public key encryption method can be realized as an internal process that does not directly involve the user's operation. Accordingly, such an arrangement should be able to avoid, almost completely, the issue of trade-off between improved security and a complicated user interface.

An arrangement may be made in which, in a case that the region specifying input unit has not received the input data that allows the region of the encryption target data to be identified, the encryption processing unit sets the text data, which is the contents of the document file, to the encryption target data before it is encrypted.

An arrangement may be made in which, in a case that the document editor has not specified the region of the encryption target data, the entire region of the text data is set to the encryption target. With such an arrangement, encryption is executed even if the document editor has not specified the region of the encryption target, thereby further improving the security of the document file.

The apparatus may acquire the public key data from an external network. For example, an arrangement may be made in which the network is searched for the public key data using the ID that identifies the specified checker as a key, and encryption processing is executed using the public key data. With such an arrangement, the document editor does not need to modify the user interface even if any document checker has changed his/her own public key data. This offers a document managing system with improved ease-of-use.

The apparatus may store cipher tags for specifying the region of the encryption target data in a document file. Furthermore, the apparatus may give an instruction to input the cipher tag set at positions before and after the region specified as the encryption target data. With such an arrangement, the encryption processing unit may identify the region of the encryption target data by detecting the positions where the cipher tag set has been inserted into the document file according to the instruction.

Also, the apparatus may store communication addresses that allow each document checker to be identified on the communication network. Also, the apparatus may identify the document checker, who is to check the document file, with reference to circulation order information created by the document editor for circulating the document file among the multiple document checkers. Also, the apparatus may transmit the encrypted document file to the communication address for each document checker thus identified, and may receive the encrypted document file from the document checker after it has been checked. With such an arrangement, the apparatus may identify the next document checker who is to check the document file in the next stage after it has been checked by the current document checker with reference to the circulation order information. Also, an arrangement may be made in which, upon reception of the encrypted document file from the document checker after it has been checked, the apparatus inserts a checker ID into the encrypted document file for identifying the document checker who has checked the document file.

The apparatus may transmit the circulation order information to the communication address of the first document checker, who is to check the document file in the first stage, as well as transmitting the document file.

Another aspect of the present invention relates to a document checking apparatus having a communication address assigned corresponding to a document checker, and which is connected to the document processing apparatus via the communication network. The apparatus may receive the encrypted document file and the circulation order information transmitted from the document processing apparatus. Also, the apparatus may decrypt at least a part of the encrypted document file using the private key data. With such an arrangement, the apparatus may transmit the encrypted document file thus decrypted and the circulation order information to the communication address of the next checker who is to check the document file in the next stage, with reference to the circulation order information.

Yet another aspect of the present invention also relates to another document checking apparatus having a communication address assigned corresponding to a document checker, and which is connected to the aforementioned document checking apparatus via the communication network. The apparatus may receive the encrypted document file and the circulation order information transmitted from the aforementioned document checking apparatus. Also, the apparatus may decrypt at least a part of the encrypted document file using the private key data. With such an arrangement, the apparatus may transmit the encrypted document file thus decrypted to the communication address of the next checker who is to check the document file in the next stage, with reference to the circulation order information.

Also, the apparatus may display the contents of the encrypted document file after it has been decrypted, and may allow the document checker to input data which indicates that the contents of the encrypted document file has been checked. Also, an arrangement may be made in which, upon reception of the input data which indicates that it has been checked, the apparatus transmits the check information, which indicates that the contents of the encrypted document file has been checked, to the document checking apparatus.

With such arrangements, the encrypted document file transmitted from the document managing apparatus is sequentially circulated among the document checking apparatus. Such an arrangement allows the user of the document managing apparatus to monitor the state, in which the encrypted document file has been checked, by receiving the check information.

Yet another aspect of the present invention relates to a document processing method. The document processing method comprises: a step for displaying the contents of a document file, which is to be encrypted, on a screen; a step for allowing a document editor to input data that specifies the region of encryption target data in the document file displayed on the screen; a step for allowing the document editor to input data that specifies document checkers who are to check the encryption target data; a step for detecting public key data that corresponds to private key data of each document checker thus specified by searching a recording medium that stores public key data that corresponds to the private key data held by the document checkers; a step for creating encrypted data by encrypting the encryption target data according to a public key encryption method using the public key data thus detected; and a step for creating an encrypted document file by replacing the encryption target data specified in the document file with the encrypted data thus created.

Such an arrangement has the advantage of providing the improved security and ease-of-use for the user in document management without trade-off therebetween.

Note that any combination of the aforementioned components or any manifestation of the present invention realized by replacement of a method, an apparatus, a system, a computer program, a recording medium storing a computer program, a data structure, and so forth, is effective as an embodiment of the present invention.

[Advantages]

The present invention provides an effective document file management technique.

### BRIEF DESCRIPTION OF THE DRAWINGS

FIG. 1 is a diagram which shows a configuration of a document processing apparatus according to the background technique.

FIG. 2 is a diagram which shows an example of an XML document which is to be edited by the document processing apparatus.

FIG. 3 is a diagram which shows an example in which the XML document shown in FIG. 2 is mapped to a table described in HTML.

FIG. 4(a) is a diagram which shows an example of a definition file used for mapping the XML document shown in FIG. 2 to the table shown in FIG. 3.

FIG. 4(b) is a diagram which shows an example of a definition file used for mapping the XML document shown in FIG. 2 to the table shown in FIG. 3.

FIG. 5 is a diagram which shows an example of a screen on which the XML document shown in FIG. 2 is displayed after having been mapped to HTML according to the correspondence shown in FIG. 3.

FIG. 6 is a diagram which shows an example of a graphical user interface provided by a definition file creating unit, which allows the user to create a definition file.

FIG. 7 is a diagram which shows another example of a screen layout created by the definition file creating unit.

FIG. 8 is a diagram which shows an example of an editing screen for an XML document, as provided by the document processing apparatus.

FIG. 9 is a diagram which shows another example of an XML document which is to be edited by the document processing apparatus.

FIG. 10 is a diagram which shows an example of a screen on which the document shown in FIG. 9 is displayed.

FIG. 11 is a hardware configuration diagram which shows a consensus-building system.

FIG. 12 is a functional block diagram which shows a document processing apparatus.

FIG. 13 is a functional block diagram which shows a document checking apparatus.

FIG. 14 is a diagram which shows a source file created by a proposer.

FIG. 15 is a diagram which shows a creating-mode editing screen displayed in a format based upon a predetermined style sheet.

FIG. 16 is a diagram which shows a source file displayed in a checking mode in a case that an unauthorized user has acquired the consensus-building document file.

FIG. 17 is a diagram which shows a checking-mode screen on which the source file shown in FIG. 16 has been displayed in a format based upon a predetermined style sheet.

FIG. 18 is a diagram which shows the source file acquired by a consensus-building staff member with the access level 1.

FIG. 19 is a diagram which shows a checking-mode screen on which the source file shown in FIG. 18 has been displayed in a format based upon a predetermined style sheet.

FIG. 20 is a diagram which shows the source file acquired by a consensus-building staff member with the access level 2.

FIG. 21 is a diagram which shows a checking-mode screen on which the source file shown in FIG. 20 has been displayed in a format based upon a predetermined style sheet.

FIG. 22 is a diagram which shows the source file acquired by a consensus-building staff member with the access level 3.

FIG. 23 is a diagram which shows a checking-mode screen on which the source file shown in FIG. 22 has been displayed in a format based upon a predetermined style sheet.

FIG. 24 is a flowchart which shows a procedure of an encryption process for the consensus-building document file.

FIG. 25 is a sequence diagram which shows a circulation process for the consensus-building document file.

### REFERENCE NUMERALS

20 document processing apparatus
22 main control unit
24 editing unit
30 DOM unit
32 DOM provider
34 DOM builder
36 output unit
40 CSS unit
42 CSS parser
44 CSS provider
46 rendering unit
50 HTML unit
52, 62 control unit
54, 64 edit unit
56, 66 display unit
60 SVG unit
72 document acquisition unit
74 namespace URI acquisition unit
76 definition file name creating unit
80 VC unit
82 mapping unit
84 definition file acquisition unit
86 definition file generator
100 consensus-building system
200 document processing apparatus
202 creating interface processing unit
204 communication unit
206 data processing unit
208 data storage unit
210 document display unit
212 input processing unit
214 encryption region specifying unit
216 access level setting unit
218 circulation order setting unit
220 document communication unit
222 public key acquisition unit
224 transmission destination identifying unit
230 data extraction unit
232 key search unit
234 encryption processing unit
240 document storage unit
242 public key storage unit
244 circulation order storage unit
300 document checking apparatus
302 checking interface processing unit
304 data processing unit
306 document communication unit
308 data storage unit
310 document display unit
312 input processing unit
320 data extraction unit
322 decryption processing unit
330 document storage unit
332 private key storage unit

### BEST MODE FOR CARRYING OUT THE INVENTION

Description will be made below regarding the background technique for the present invention before detailed description of the present embodiment.

(Background Technique)

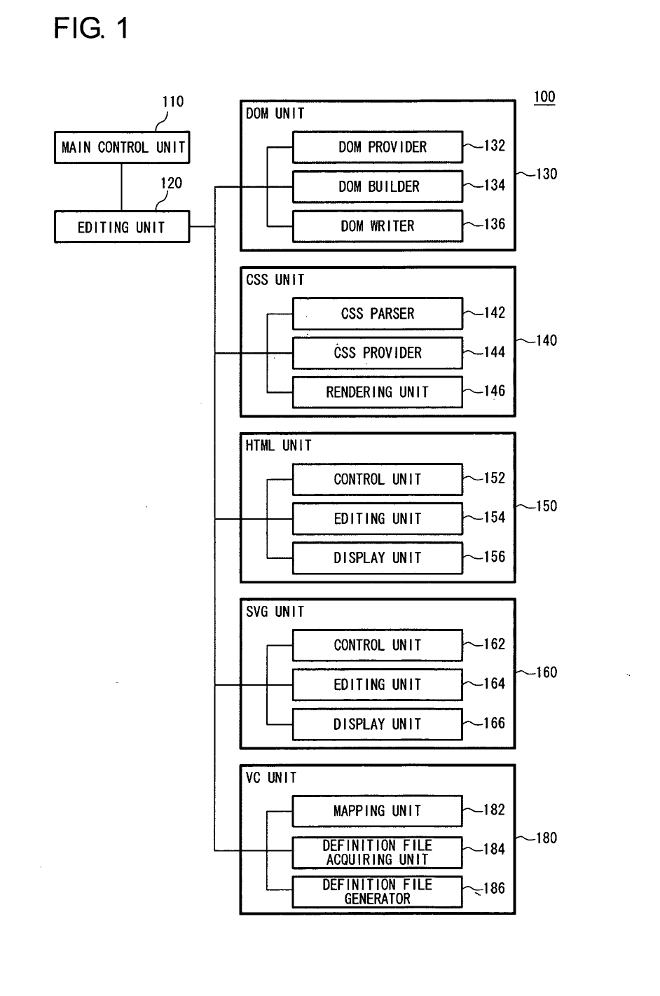

FIG. 1 illustrates a structure of a document processing apparatus 20 according to the background technique. The document processing apparatus 20 processes a structured document where data in the document are classified into a plurality of components having a hierarchical structure. Represented in the background technique is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it would be understood by those skilled in the art that these function blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, the HTML unit 50 and the SVG unit 60 are loaded, respectively. As will be described later, when compound documents, which contain both the HTML and SVG components, are to be processed, both the HTML unit 50 and the SVG unit 60 are loaded.

By implementing the above structure, a user can select so as to install only necessary functions, and can add or delete a function or functions at a later stage, as appropriate. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 generates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are generated. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

The HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the background technique allows an XML document to be edited according to each given vocabulary, as well as providing a function of editing the HTML document in the form of tree display. The HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the background technique, this function is called a vocabulary connection (VC). In the VC unit 80, the definition file acquiring unit 84 acquires a script file in which the mapping definition is described. Here, the definition file specifies the correspondence (connection) between the nodes for each node. Furthermore, the definition file may specify whether or not editing of the element values or attribute values is permitted. Furthermore, the definition file may include operation expressions using the element values or attribute values for the node. Detailed description will be made later regarding these functions. The mapping unit 82 instructs the DOM builder 34 to generate a destination tree with reference to the script file acquired by the definition file acquiring unit 84. This manages the correspondence between the source tree and the destination tree. The definition file generator 86 offers a graphical user interface which allows the user to generate a definition file.

The VC unit 80 monitors the connection between the source tree and the destination tree. Upon reception of an editing instruction from the user via a user interface provided by a plug-in that handles a display function, the VC unit 80 first modifies a relevant node of the source tree. As a result, the DOM unit 30 issues a mutation event indicating that the source tree has been modified. Upon reception of the mutation event thus issued, the VC unit 80 modifies a node of the destination tree corresponding to the modified node, thereby updating the destination tree in a manner that synchronizes with the modification of the source tree. Upon reception of a mutation event that indicates that the destination tree has been modified, a plug-in having functions of displaying/editing the destination tree, e.g., the HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 generates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and generates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

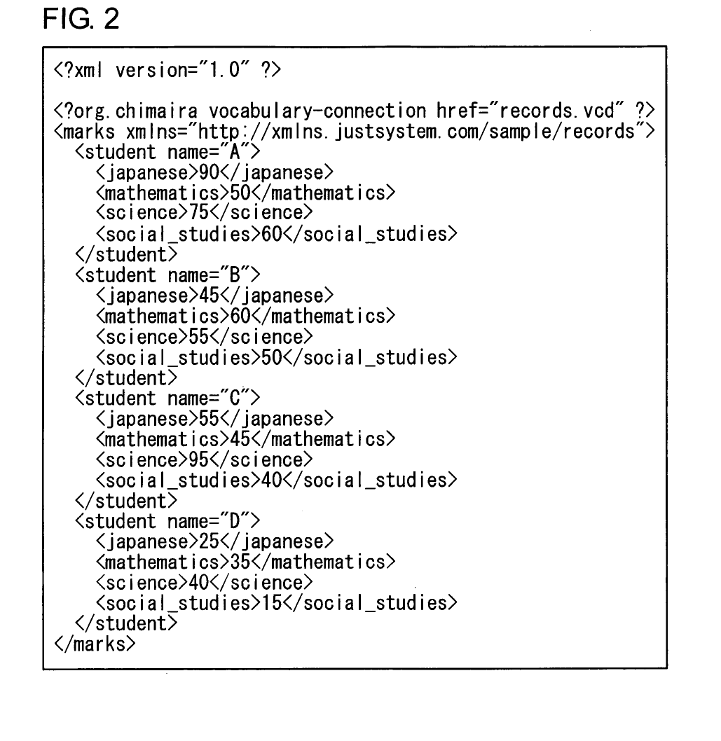

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the background technique does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

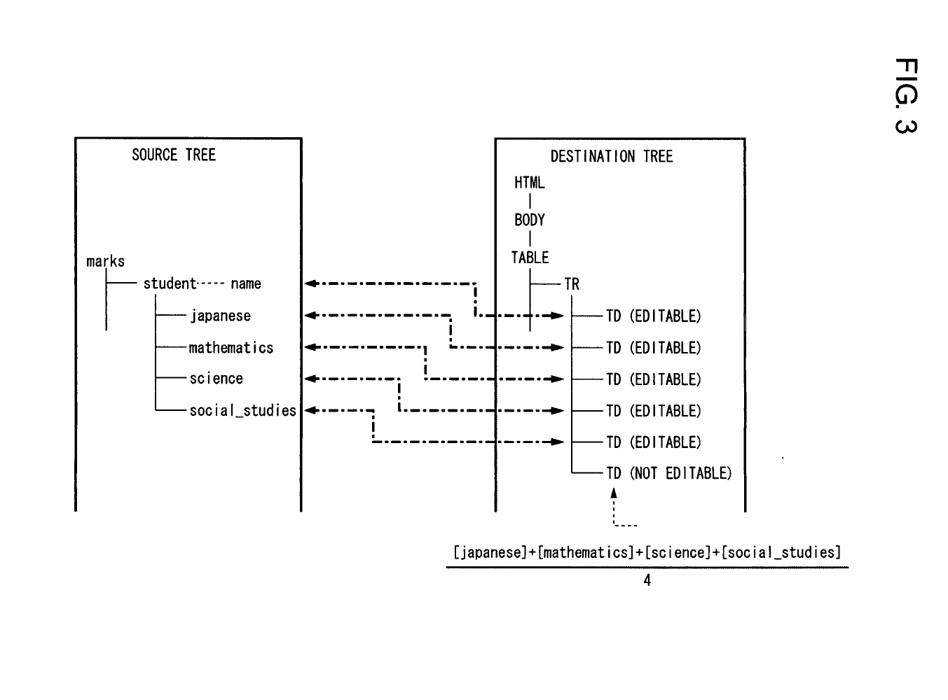

FIG. 3 shows an example in which the XML document shown in FIG. 2 is mapped to a table described in HTML. In an example shown in FIG. 3, a “student” node in the marks managing vocabulary is associated with a row (“TR” node) of a table (“TABLE” node) in HTML. The first column in each row corresponds to an attribute value “name”, the second column to a “japanese” node element value, the third column to a “mathematics” node element value, the fourth column to a “science” node element value and the fifth column to a “social_studies” node element value. As a result, the XML document shown in FIG. 2 can be displayed in an HTML tabular format. Furthermore, these attribute values and element values are designated as being editable, so that the user can edit these values on a display screen using an editing function of the HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

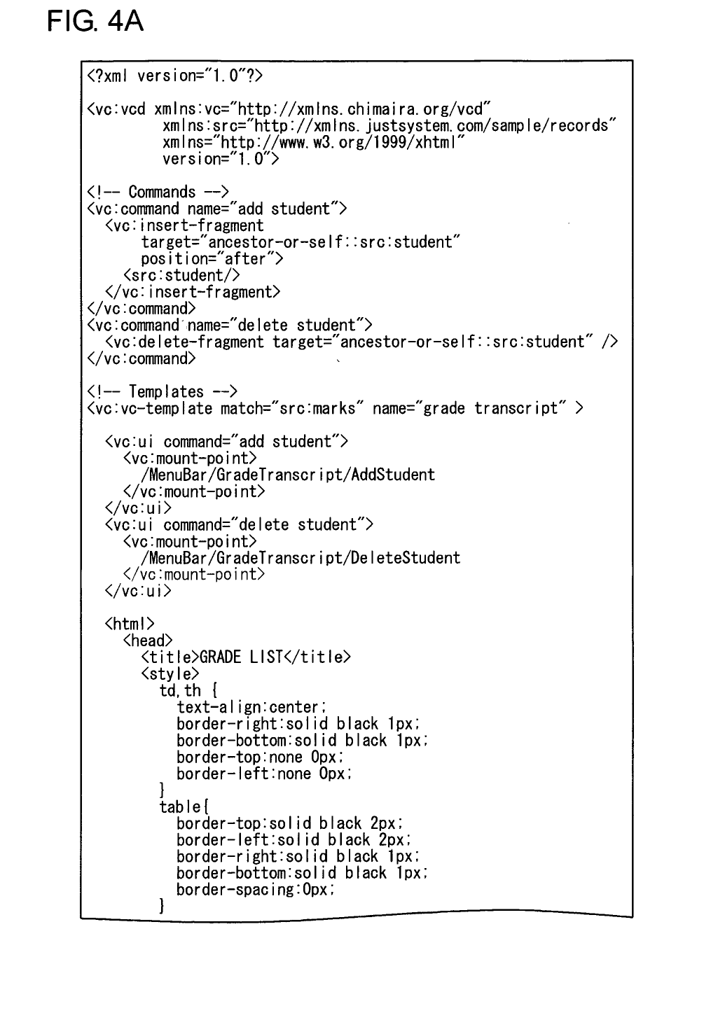

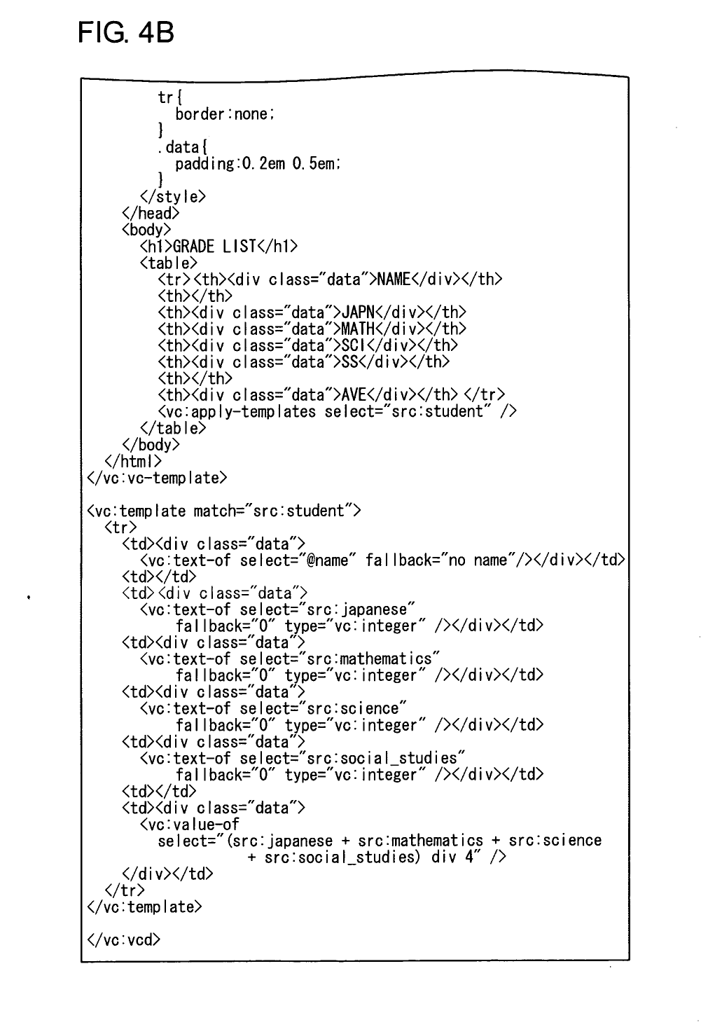

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a node “student” into a source tree and an operation of deleting the node “student” from the source tree, respectively, are associated with these commands. Furthermore, the definition file is described in the form of a template, which describes that a header, such as “name” and “japanese”, is displayed in the first row of a table and the contents of the node “student” are displayed in the second and subsequent rows. In the template displaying the contents of the node “student”, a term containing “text-of” indicates that editing is permitted, whereas a term containing “value-of” indicates that editing is not permitted. Among the rows where the contents of the node “student” are displayed, an operation expression “(src:japanese+src:mathematics+scr:science+scr:social_studies) div 4” is described in the sixth row. This means that the average of the student's marks is displayed.

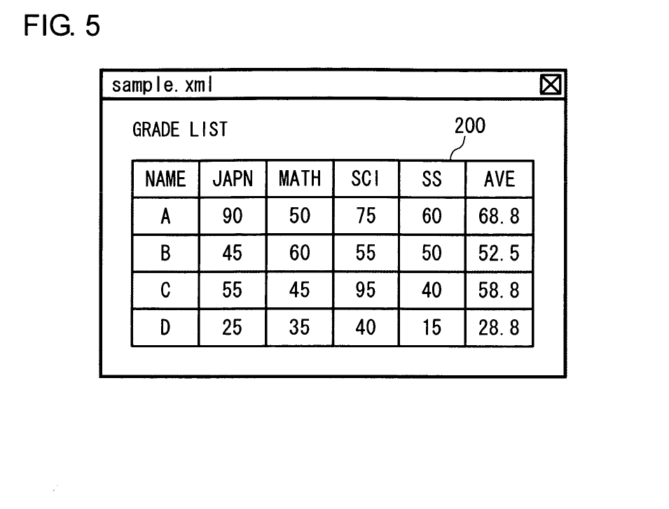

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the name of each student, marks for Japanese, marks for mathematics, marks for science, marks for social studies and the averages thereof. The user can edit the XML document on this screen. For example, when the value in the second row and the third column is changed to “70”, the element value in the source tree corresponding to this node, that is, the marks of student “B” for mathematics are changed to “70”. At this time, in order to have the destination tree follow the source tree, the VC unit 80 changes a relevant portion of the destination tree accordingly, so that the HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a node “student” is added or deleted in the source tree. In this manner, with the document processing apparatus 20 according to the background technique, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of the HTML unit 50.

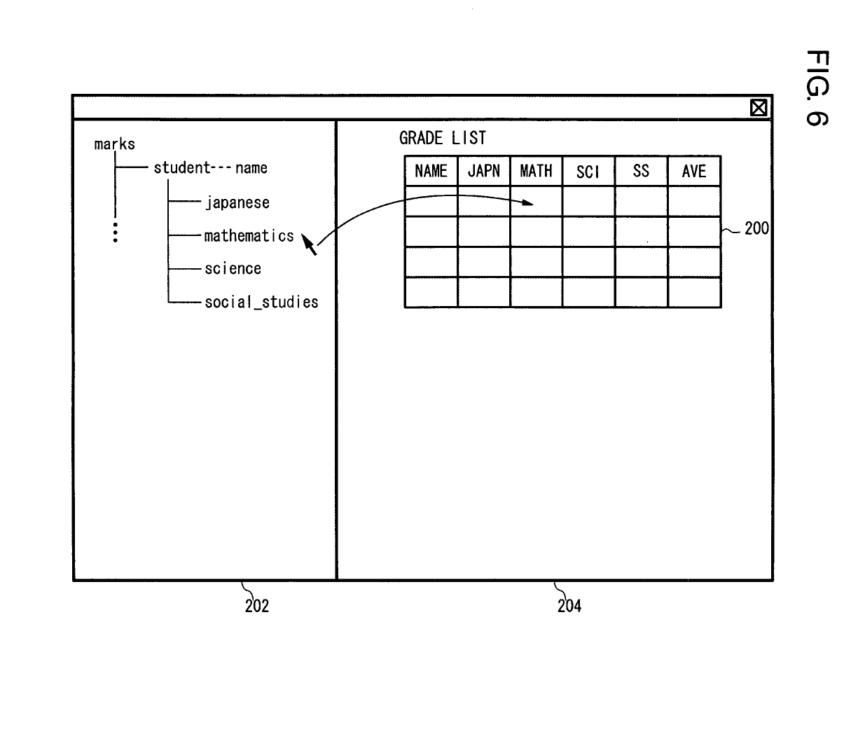

FIG. 6 shows an example of a graphical user interface, which the definition file generator 86 presents to the user, in order for the user to generate a definition file. An XML document to be mapped is displayed in a tree in a left-hand area 91 of a screen. The screen layout of an XML document after mapping is displayed in a right-hand area 92 of the screen. This screen layout can be edited by the HTML unit 50, and the user creates a screen layout for displaying documents in the right-hand area 92 of the screen. For example, a node of the XML document which is to be mapped, which is displayed in the left-hand area 91 of the screen, is dragged and dropped into the HTML screen layout in the right-hand area 92 of the screen using a pointing device such as a mouse, so that a connection between a node at a mapping source and a node at a mapping destination is specified. For example, when “mathematics,” which is a child element of the element “student,” is dropped to the intersection of the first row and the third column in a table 90 on the HTML screen, a connection is established between the “mathematics” node and a “TD” node in the third column. Either editing or no editing can be specified for each node. Moreover, the operation expression can be embedded in a display screen. When the screen editing is completed, the definition file generator 86 generates definition files, which describe connections between the screen layout and nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

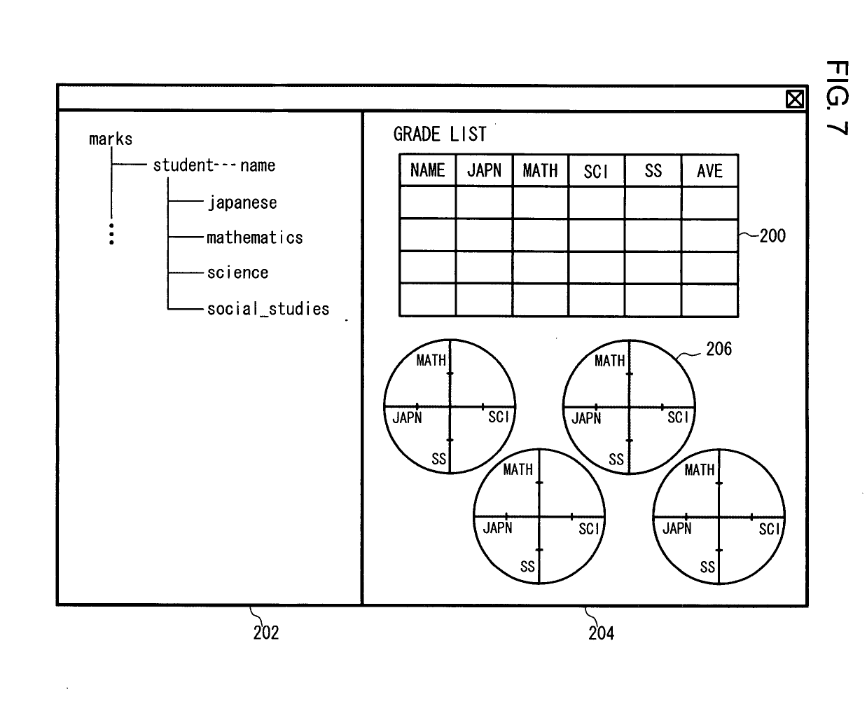

FIG. 7 shows another example of a screen layout generated by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the background technique can process a compound document described in the form of a single XML document according to a plurality of vocabularies. That is why the table 90 described in HTML and the circular graphs 93 described in SVG can be displayed on the same screen.

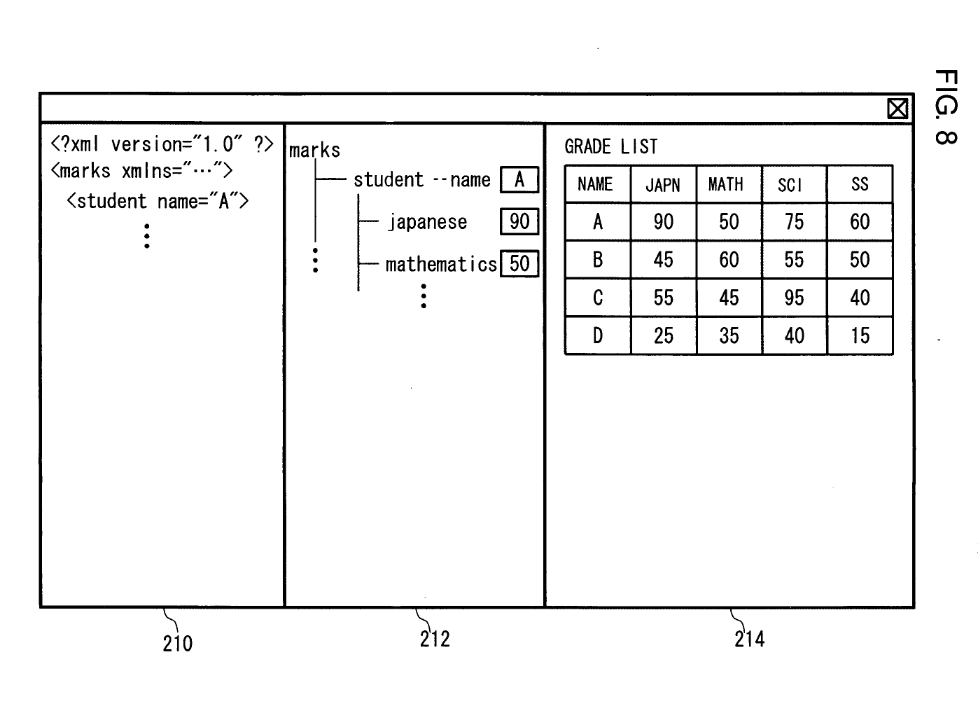

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, the HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to the HTML structure thus laid out, and the HTML unit 50 displays the XML document thus mapped. In such an arrangement, three destination trees in the source format, the tree format and the table format are generated. If the editing is carried out in any of the three areas on the screen, the VC unit 80 modifies the source tree and, thereafter, modifies the three destination trees in the source format, the tree format and the table format. Then, the HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

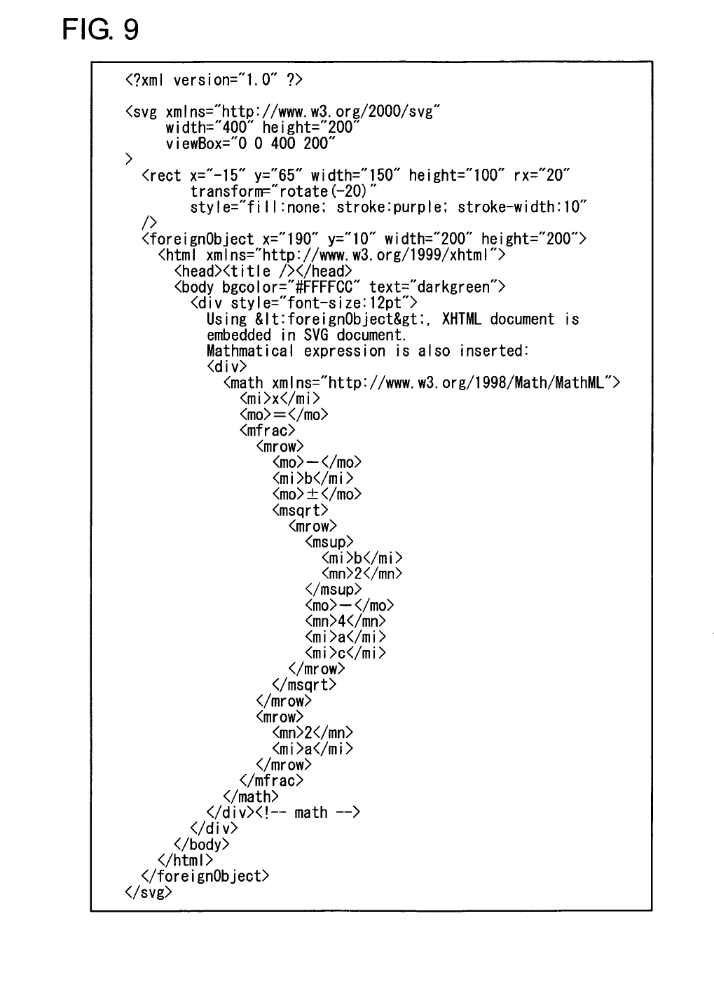

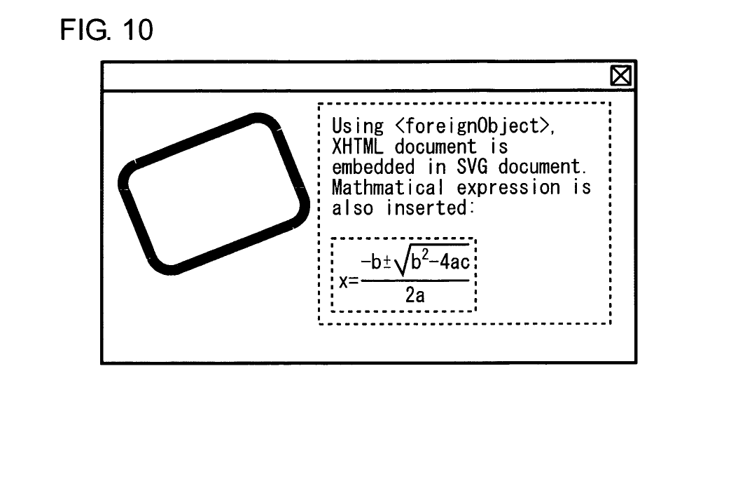

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs the HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by the HTML unit 50, or a command set which is defined in the definition file for mapping the HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the background technique, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the order of importance.

When the user edits a document on an edit screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node which lies lower than the <html> node is modified, the mutation event is notified to the HTML unit 50, which is registered as a listener to the <html> node. At the same time, the mutation event is also notified to the SVG unit 60, which is registered as a listener in an <svg> node, which lies upper to the <html> node. At this time, the HTML unit 50 updates the display by referring to the modified source tree. Since the nodes belonging to the vocabulary of the SVG unit 60 itself are not modified, the SVG unit 60 may disregard the mutation event.

Depending on the contents of the editing, modification of the display by the HTML unit 50 may change the overall layout. In such a case, the layout is updated by a screen layout management mechanism, e.g., the plug-in that handles the display of the highest node, in increments of display regions which are displayed according to the respective plug-ins. For example, in a case of expanding a display region managed by the HTML unit 50, first, the HTML unit 50 renders a part managed by the HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### EMBODIMENT

First, an overall description will be made regarding the public key encryption method employed in a document processing apparatus according to the present embodiment. Subsequently, on basis of the description regarding the public key encryption method, description will be made regarding a configuration and functions of the document processing apparatus according to the present embodiment.

The feature of the public key encryption method is that an encryption key and a decryption key differ from one another. There are various public key encryption methods put into practical use. Examples of such public key encryption methods include: RSA (Rivest Shamir Adleman) encryption; Rabin encryption; Elgamal encryption; etc. In any one of these public key encryption methods, a pair of keys, i.e., a public key and a private key, provides encryption processing and decryption processing. With such a public key encryption method, decryption of the data encrypted using the public key requires the private key. On the other hand, decryption of the data encrypted using the private key requires the public key. That is to say, the data encrypted using the public key cannot be decrypted using the same public key. Also, the data encrypted using the private key cannot be decrypted using the same private key.

Let us consider an example of a practical application. With such an arrangement, the user discloses his/her own public key data via a network. Furthermore, the user holds a private key that forms a pair with the public key in a private manner. In a case that another user desires to transmit data to the former user, the latter user acquires the public key data. The transmitter user encrypts the data with the public key, and transmits the encrypted data to the receiver user having the corresponding private key. As a result, the encrypted data cannot be decrypted, except for the transmitter user. With such an arrangement, the transmitter user needs the public key data. On the other hand, the receiver user needs the private key data. That is to say, the transmitter user and the receiver user does not need to hold “information to be managed in a manner shared therebetween”. The public key encryption method exhibits high security and provides ease-of-use for the user, which are excellent properties. The public key data is disclosed via a server, i.e., a so-called public key server. Such an arrangement allows each transmitter user to search for the corresponding public key based upon the destination user name. Such a public key server allows each transmitter user to acquire proper public key data without being concerned about whether or not the public key data of the receiver user has been changed.

The document processing apparatus according to the present embodiment encrypts a document file according to the public key encryption method. Description will be made below regarding an arrangement of a consensus-building system.

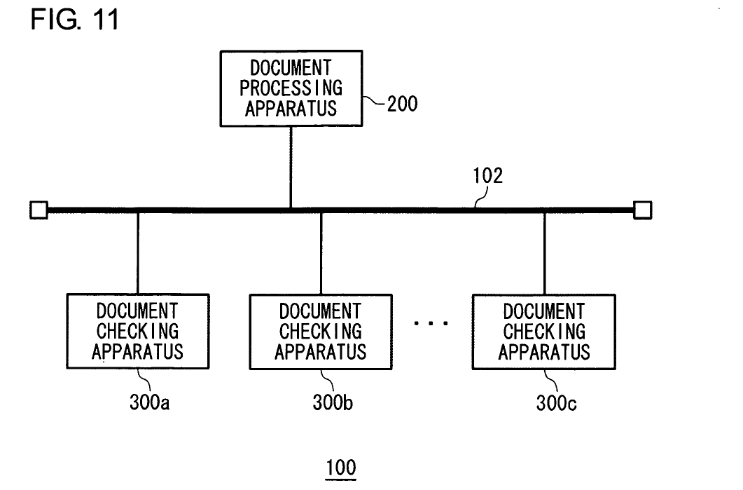

FIG. 11 is a hardware configuration diagram which shows a consensus-building system 100. A document processing apparatus 200 transmits a document file to multiple terminals such as a document checking apparatus 300a, a document checking apparatus 300b, a document checking apparatus 300c, etc., (which will be collectively referred to as “document checking apparatus 300” hereafter) connected with each other via a LAN (Local Area Network) 102. In the present embodiment, the document file will be referred to as “consensus-building document” or “consensus-building document file”.

The document processing apparatus 200 registers a consensus-building document file. The proposer, who is a document editor, encrypts the entire data or a part of the data included in the consensus-building file thus registered, according to the access authority of each checker.

The document checking apparatus 300 are terminals assigned to the respective consensus-building staff members. The consensus-building staff member who is a document checker accesses the consensus-building file transmitted from the document processing apparatus 200 via his/her own document checking apparatus 300. The document checking apparatus 300 transmits the consensus-building document file after it has been checked. In this case, such an arrangement allows the consensus-building staff member to attach his/her decision to the consensus-building document file whether the items in the consensus-building document file thus checked are to be approved or rejected. Upon reception of the consensus-building document file from the document checking apparatus 300, the document processing apparatus 200 identifies the next destination, and transmits the consensus-building document file to the next destination. The consensus-building document file is circulated as described above.

Next, description will be made regarding the functions of the document processing apparatus 200 and the functions of the document checking apparatus 300.

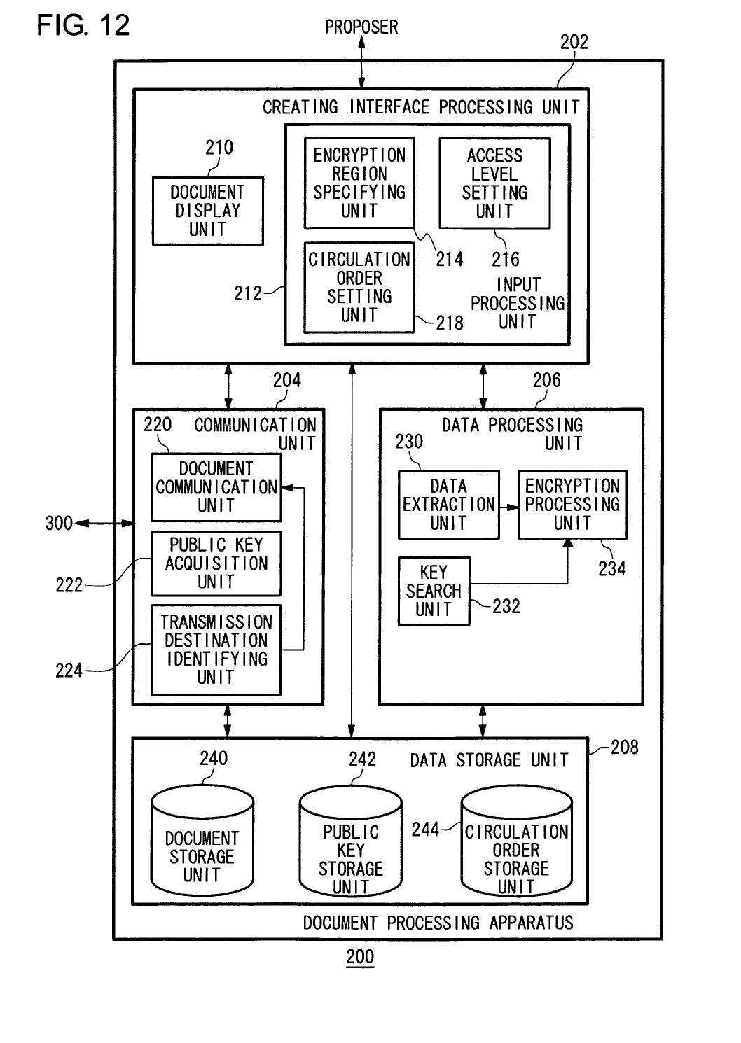

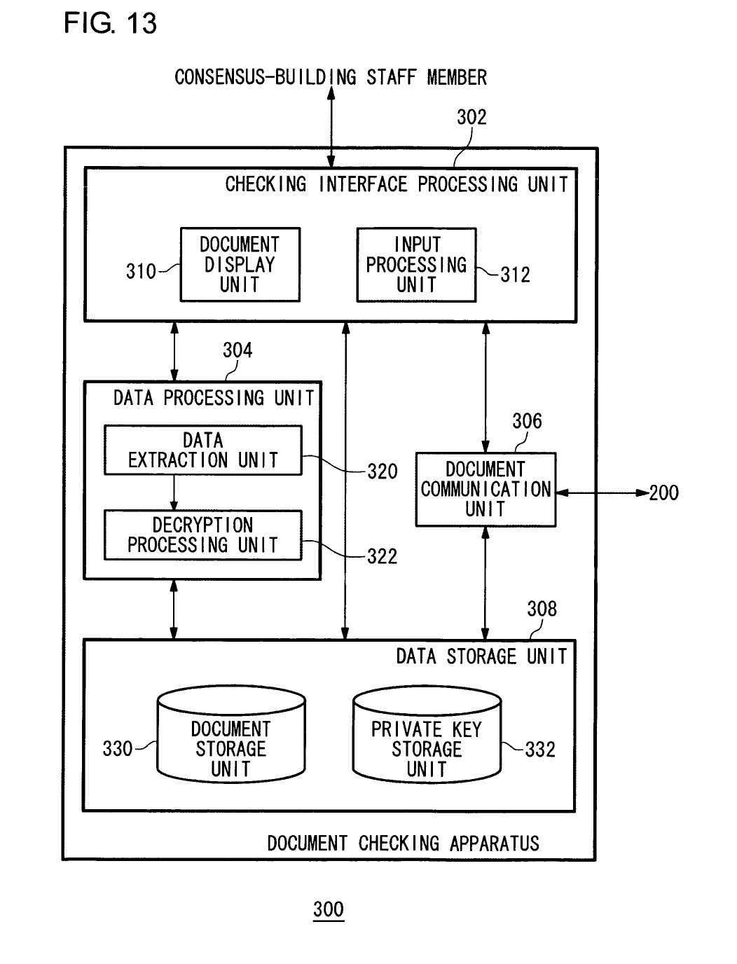

FIG. 12 is a functional block diagram which shows the document processing apparatus 200. The document processing apparatus 200 and the document checking apparatus 300 which will be described with reference to FIG. 13 may be realized by hardware means, e.g., by actions of a CPU of a computer and other components, and by software means, e.g., by actions of a program or the like that provides a data transmission/reception function. Here, FIG. 12 and FIG. 13, which will be described below, show functional block configurations realized by cooperation of the hardware components and software components. That is to say, such a functional block configuration can be realized in various forms by making various combination of the hardware components and the software components. The document processing apparatus 200 may have a configuration including a web server. Also, the document checking apparatus 300 may have a configuration including a personal computer and a web browser installed in the personal computer.

The document processing apparatus 200 includes a creating interface processing unit 202, a communication unit 204, a data processing unit 206, and a data storage unit 208. The creating interface processing unit 202 provides a function of performing user interface processing that allows the proposer to operate the document processing apparatus 200. The data processing unit 206 acquires an instruction input by the proposer via the creating interface processing unit 202, and performs processing of the data included in the consensus-building document file. The communication unit 204 transmits/receives the consensus-building document file to/from the document checking apparatuses 300, and controls the circulation of the consensus-building document file. The data storage unit 208 stores various kinds of data sets.

The data storage unit 208 includes a document storage unit 240, a public key storage unit 242, and a circulation order storage unit 244.

The document storage unit 240 stores consensus-building document files. Specifically, the document storage unit 240 stores both of the consensus-building document file before encryption and the consensus-building document file after encryption. In order to classify these consensus-building document files, the former will be referred to as “unencrypted consensus-building document file” hereafter. On the other hand, the latter will be referred to as “encrypted consensus-building document file” hereafter.

The public key storage unit 242 stores public key data for each consensus-building staff member. The setting of the level, which is a so-called “access level”, is made for each consensus-building staff member. The consensus-building document file is disclosed in a multi-level manner according to the access level. With such an arrangement, the private key data and the public key data are set based upon the access level. For example, let us consider a case of a second level consensus-building staff member with the access level of “2”. In this case, the second level consensus-building staff member holds the private key data that corresponds to the level 2. The access level may be set based upon various factors. Examples of such factors include a position, duties, etc. The public key storage unit 242 stores public key data that corresponds to each access level.

The circulation order storage unit 244 stores circulation order information used for circulating a consensus-building document file among multiple consensus-building staff members.

The creating interface processing unit 202 includes a document display unit 210 and an input processing unit 212.

The document display unit 210 displays the consensus-building document file, which is stored in the document storage unit 240, on a screen. With the present embodiment, the consensus-building document file is described in XML. The document display unit 210 may display the consensus-building document file in the form of an XML source file or in a format created based upon a predetermined style sheet.

The input processing unit 212 allows the proposer to input data. The input processing unit 212 includes an encryption region specifying unit 214, an access level setting unit 216, and a circulation order setting unit 218.

The encryption region specifying unit 214 detects the input for specifying the data region in the consensus-building document file which is to be encrypted for access limitation. The access level setting unit 216 detects the input by the proposer for setting the access level with respect to the encryption target data thus detected by the encryption region specifying unit 214. The region of the encryption target data and the corresponding access level, which have been received by the encryption region specifying unit 214 and the access level setting unit 216, are used for modifying the consensus-building document file in the form of XML tags.

The circulation order setting unit 218 allows the proposer to input data with respect to the order for circulating the consensus-building document file. The circulation order information thus input is stored in the circulation order storage unit 244.

The data processing unit 206 includes a data extraction unit 230, a key search unit 232, and an encryption processing unit 234.

The data extraction unit 230 creates a duplicate of the encryption target data detected by the encryption region specifying unit 214, and transfers the duplicate to another region that differ from the region in the memory where the consensus-building document file is stored. The key search unit 232 searches the public key storage unit 242 for the public key data that corresponds to the access level detected by the access level setting unit 216. The encryption processing unit 234 encrypts the encryption target data, which has been extracted by the data extraction unit 230, using the public key data thus detected by the key search unit 232. The encryption processing unit 234 replaces the encryption target data included in the unencrypted consensus-building document file with the data thus encrypted, thereby creating an encrypted consensus-building document file.

An arrangement may be made in which, upon reception the consensus-building document file thus returned from the consensus-building staff member after it has been checked, the data processing unit 206 adds a signature to the consensus-building document file for identifying the consensus-building member. Also, an arrangement may be made in which such a signature is added by the document checking apparatus 300. Description will be made below regarding such an arrangement in which the signature of the consensus-building member is added by the document checking apparatus 300. The signature may be displayed on the browser.

Note that, in a case that the encryption region specifying unit 214 has not received the input data that specifies the encryption target region from the proposer, the entire region of the text data in the consensus building document file is set to the encryption target region.

The communication unit 204 includes a document communication unit 220, a public key acquisition unit, and a transmission destination identifying unit 224.

The document communication unit 220 transmits an encrypted consensus-building document file to the document checking apparatus 300. Also, the document communication unit 220 receives the consensus-building document file from the document checking apparatus 300 after it has been checked by the consensus-building staff member. The public key acquisition unit 222 acquires public key data disclosed via a network. For example, a public key database in which the access level and the public key data are associated with each other may be connected to the LAN 102. With such an arrangement, the public key acquisition unit 222 may acquire the public key data that corresponds to the access level, which has been specified via the access level setting unit 216, from the public key data base. With such an arrangement, the proposer does not need to be concerned about whether or not the public key data that corresponds to the access level has been changed.

The transmission destination specifying unit 224 identifies the document checking apparatus 300, to which the document communication unit 220 is to transmit the consensus-building file, based upon the circulation order information stored in the circulation order information storage unit 244.

As described above, the unencrypted consensus-building document file is translated into the encrypted consensus-building document file, and the encrypted consensus-building document file is circulated among the consensus-building staff members.

FIG. 13 is a functional block diagram which shows the document checking apparatus 300.

The document checking apparatus 300 includes a checking interface processing unit 302, a data processing unit 304, a document communication unit 306, and a data storage unit 308.

The checking interface processing unit 302 provides a function of performing user interface processing that allows the user to operate the document checking apparatus 300. The data processing unit 304 acquires an instruction input from the proposer via the checking interface processing unit 302, and performs processing for the data of the consensus-building document file. The document communication unit 306 transmits/receives the consensus-building document file to/from the document processing apparatus 200. The data storage unit 308 stores various kinds of data.

The data storage unit 308 includes a document storage unit 330 and a private key storage unit 332.

The document storage unit 330 stores the encrypted consensus-building document file received by the document communication unit 306. The private key storage unit 332 stores the private key data of the consensus-building staff member. The private key data is key data that corresponds to the access level set for each consensus-building staff member.

The checking interface processing unit 302 includes a document display unit 310 and an input processing unit 312.

The document display unit 310 displays the encrypted consensus-building document file stored in the document storage unit 330 on a screen. The document display unit 310 may display the consensus-building document file in the form of an XML source file, or in a format based upon a predetermined style sheet. The input processing unit 312 allows the proposer to input data.

The data processing unit 304 includes a data extraction unit 320 and a decryption processing unit 322. The data extraction unit 320 detects the region of the encrypted data from the data included in the encrypted consensus-building document file stored in the document storage unit 330. The cipher tags described later are inserted into the region of the encrypted data in the encrypted consensus-building document file. The data extraction unit 320 detects the position and the region of the encrypted data using the cipher tags as marks. Then, the data extraction unit 320 creates a duplicate of the encrypted data, and transmits the duplicate to a region that differs from the region where the encrypted consensus-building document file has been loaded in the memory.

The decryption processing unit 322 decrypts the encrypted data, which has been extracted by the data extraction unit 320, using the private key data stored in the private key storage unit 332. Note that the decryption processing unit 322 requires the private key data that corresponds to the access level specified in the encrypted consensus-building document file for decrypting the encrypted data. The encryption processing unit 322 decrypts the encrypted data included in the encrypted consensus-building document file, and replacement is performed, thereby providing the unencrypted data. The document communication unit 306 transmits the consensus-building document file thus decrypted to the document checking apparatus 300. Upon reception of the consensus-building document file, the document communication unit 306 adds the signature of the consensus-building staff member to the consensus-building document file. The document communication unit 306 returns the consensus-building document file, which has been decrypted by the decryption processing unit 322, to the document checking apparatus 300. Also, the document communication unit 306 returns the encrypted consensus-building document file, which has been encrypted again using the public key data, to the document checking apparatus 300.

As described above, the encrypted consensus-building document file, which has been transmitted from the document checking apparatus 300 to the document processing apparatus 200, is returned to the document checking apparatus 300 after it has been checked by the consensus-building staff member.

Next, an example of a source file of the consensus-building document file described in XML, and an example of a screen displayed corresponding to the source file are shown.

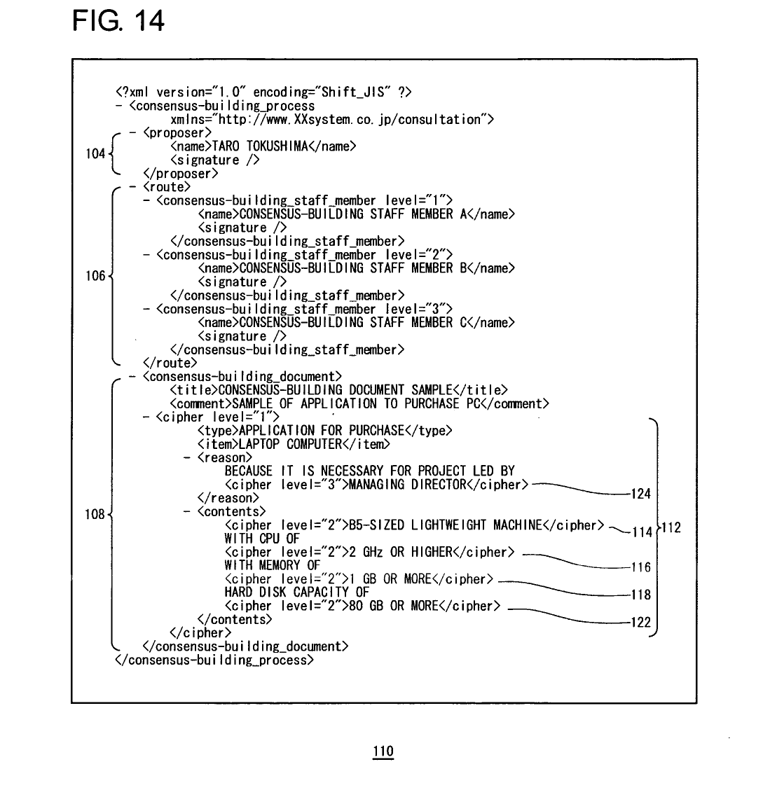

FIG. 14 is a creating-mode source file 110 edited by the proposer. In the creating-mode source file 110, a proposer information region 104 provides information for identifying the proposer. A circulation order information region 106 provides information for identifying the consensus-building staff members who can access the consensus-building document file. A consensus-building contents information region 108 provides the information with respect to the contents of the consensus-building document.

The proposer information region 104 includes the name of the proposer and a signature for identifying the proposer. The term “signature” as used here represents information that allows the consensus-building system 100 to identify the individual users.

The circulation order information region 106 includes the names, the access levels, and the signatures of the consensus-building staff members. Here, a circulation rule is set in which the consensus-building document file is to be circulated in the order of the consensus-building staff members A, B, and C. Furthermore, the access levels of the consensus-building members A, B, and C are set to “1”, “2”, and “3”, respectively. That is to say, the consensus-building file is circulated among the consensus-building staff members in ascending order of the access level. Upon reception of the consensus-building document file, the document communication unit 306 adds a signature that corresponds to the consensus-building member to a corresponding field in the consensus-building document file.

The consensus-building contents information region 108 include cipher tags. The cipher tags are used for indicating the region of the encryption target data in the same manner as the XML tags. The first level encryption region 112 represents a region which is to be encrypted using a cipher tag set with the access level 1 (which will also be referred to as “first level tag set” hereafter). That is to say, the data within the region indicated by the first level encryption region 112 is encrypted by the encryption processing unit 234 using the public key data that corresponds to the access level 1. On the other hand, before disclosure of the contents in the first level encryption region 112, decryption of the contents requires the private key data that corresponds to the access level 1.

The first level encryption region 112 includes a third level encryption region 124, and second level encryption regions 114, 116, 118, and 122, for which the corresponding cipher tags have been set. Specifically, the second level tags 2 are set for the second level encryption regions 114, 116, 118, and 122. On the other hand, the third level tag is set for the third level encryption region 124. As described above, such an arrangement allows the user to create the creating-mode source file 110 such that the regions of the encryption target data are set in a nested manner.

Such an arrangement allows the proposer to specify the region of the encryption target data in the creating-mode source file 110 by inserting the cipher tag. An arrangement may be made in which, before a GUI (Graphical User Interface) allows the user to specify instructions for encryption, the creating-mode source file 110 is displayed in a format based upon a predetermined style sheet. Next, a screen example is shown.

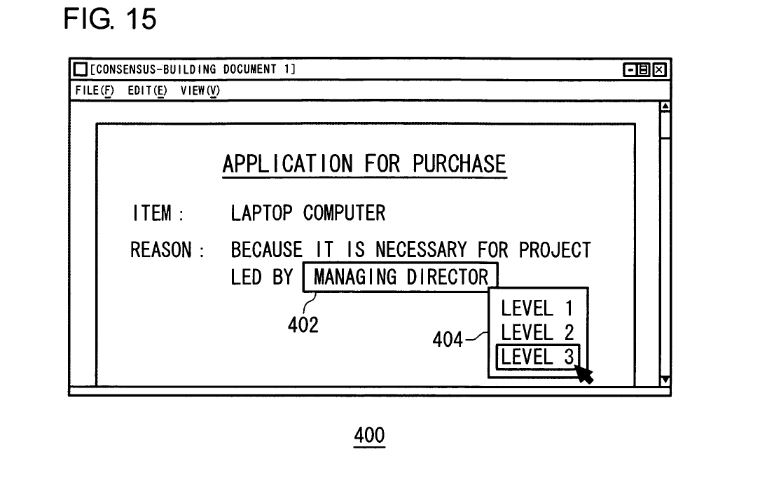

FIG. 15 shows a creating-mode editing screen 400 on which the creating-mode source file 110 shown in FIG. 14 has been displayed in a format based upon a predetermined style sheet. In this drawing, the proposer sets an encryption setting region 402 by dragging a mouse pointer. Here, the character string “managing director” has been selected and set. Upon right-clicking a mouse, an access level selection menu 404 is displayed. Then, the proposer selects the access level from the access level selection menu 404.

Now, description will be made regarding the relation with the functional block shown in FIG. 12. The encryption region specifying unit 214 identifies the region of the encryption setting region 402. The data extraction unit 230 creates a duplicate of the text data “managing director”, and transmits the duplicate to the memory. The access level setting unit 216 detects the selection made via the access level selection menu 404. In this example, the access level 3 has been selected. The key search unit 232 detects the public key data, which corresponds to the access level 3, from the public key storage unit 242. The encryption processing unit 234 encrypts the character string, which has been extracted by the data extraction unit 230, using the public key data detected by the key search unit 232. Then, the encryption processing unit 234 replaces the unencrypted character string “managing director” in the original consensus-building document file with the encrypted character string “managing director”. As described above, the encryption processing unit 234 translates the unencrypted consensus-building document file into the encrypted consensus-building document file.

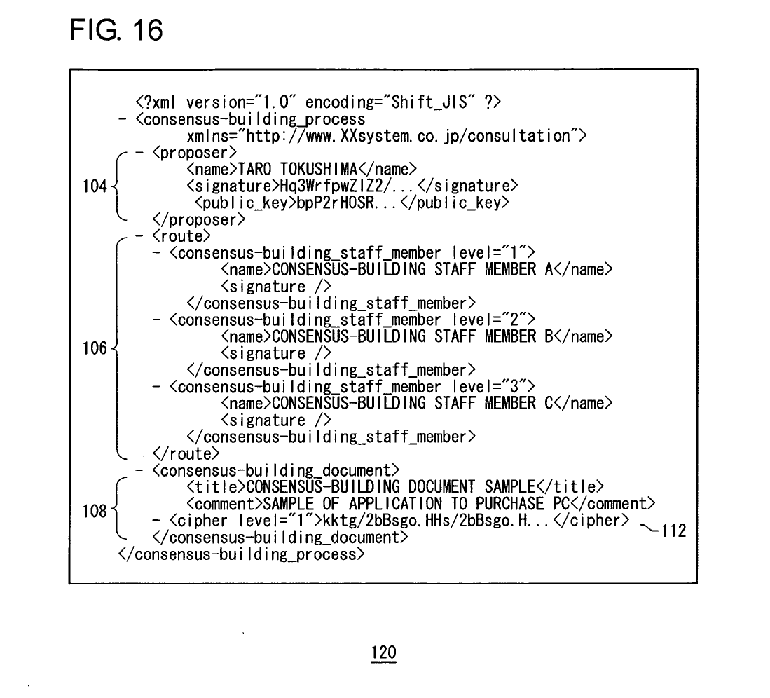

FIG. 16 shows a checking-mode source file 120 of the consensus-building document file obtained by a user having no private key data necessary for decryption (which will be referred to as “unauthorized user” hereafter). The encrypted consensus-building document file created by the document checking apparatus 300 is encrypted using the first level tag. Here, the first level tag is set for the first level encryption region 112. The unauthorized user does not have the private key data for decrypting the first level encrypted data, and accordingly, the access to the contents in the first level encryption region 112 shown in this drawing is limited. The consensus-building document file provided in the form of the creating-mode source file 110 is circulated only among the consensus-building staff members A, B, and C. Let us consider an undesired case in which an unauthorized user has received the consensus-building document file. In this case, the public key encryption method limits disclosure of the contents.

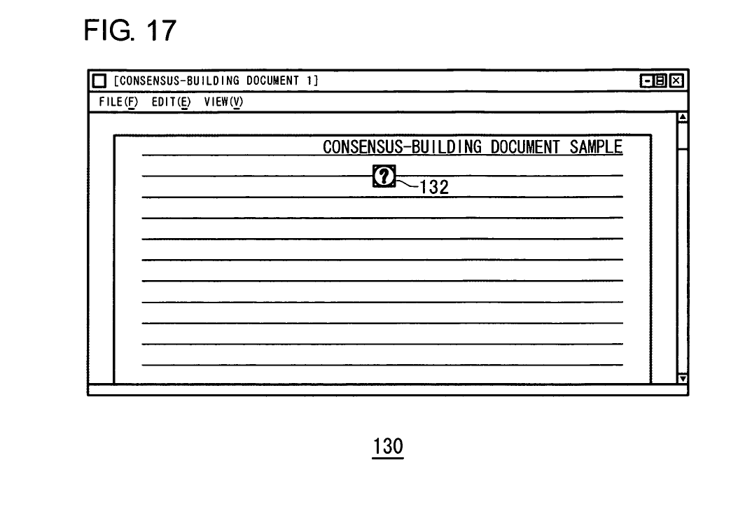

FIG. 17 shows a checking screen 130 on which the checking-mode source file 120 shown in FIG. 16 has been displayed in a format based upon a predetermined style sheet. The checking-mode source file 120 has the first level encryption region 112 that has not been decrypted, which limits the access to the contents. Accordingly, a non-disclosure icon 132, which indicates that the access is limited, is displayed corresponding to the second level encryption region 122. The data extraction unit 320 extracts the region of the encrypted data using the cipher tags included in the consensus-building document file as marks. In a case that there is no private key data for decrypting the encrypted data, the document display unit 310 displays the non-disclosure icon 132 at the corresponding position.

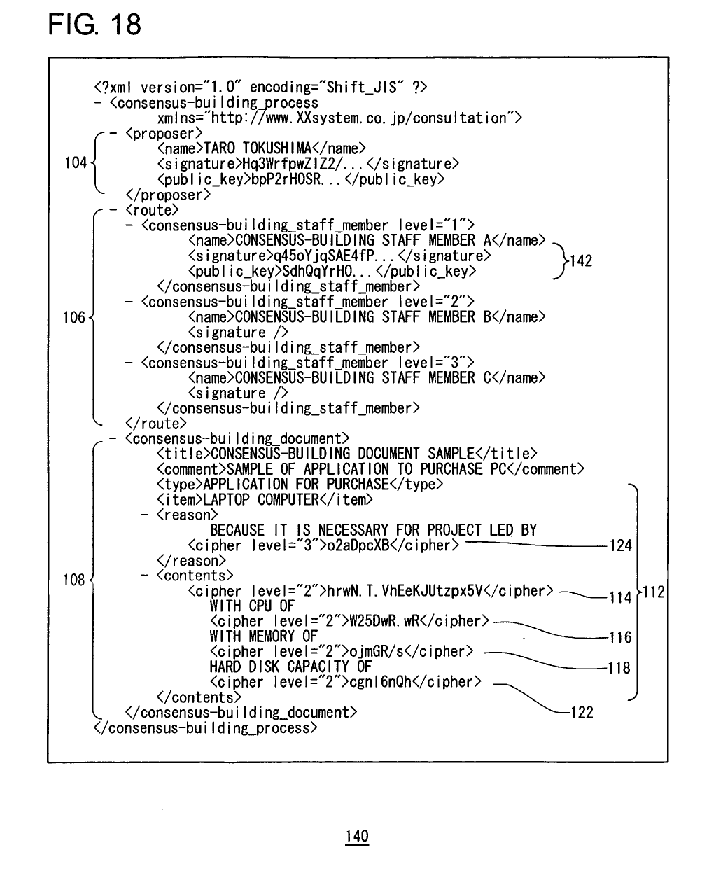

FIG. 18 shows a checking-mode source file 140 obtained by the consensus-building staff member A. Upon reception of the encrypted consensus-building document file, the document communication unit 306 adds the signature and the public key data of the consensus-building staff member A to a consensus-building staff member A signature region 142. Also, an arrangement may be made in which, upon transmission of the consensus-building document file from the document checking apparatus 300 of the consensus-building staff member A to the document processing apparatus 200 after it has been checked, the data processing unit 206 adds the signature and the public key of the consensus-building staff member A to the consensus-building document file. Such an arrangement allows the user to confirm whether or not the consensus-building document file has been checked, by confirming the consensus-building staff member A signature region 142. Furthermore, such an arrangement provides the advantage of clearly showing the train of responsibility with respect to the check or approval for the consensus-building document file after the consensus-building process.

In this drawing, the first level encryption region 112 can be decrypted using the private key data of the consensus-building staff member A. The reason is that the consensus-building staff member A is a consensus-building staff member with the access level 1. Accordingly, the contents in the first level encryption region 112 are disclosed to the consensus-building staff member A. On the other hand, access to the second level encryption regions 116, 118, and 122, and access to the third level encryption region 124 require an access right of access level 2 or higher, and accordingly, these regions are not disclosed to the consensus-building staff member A.

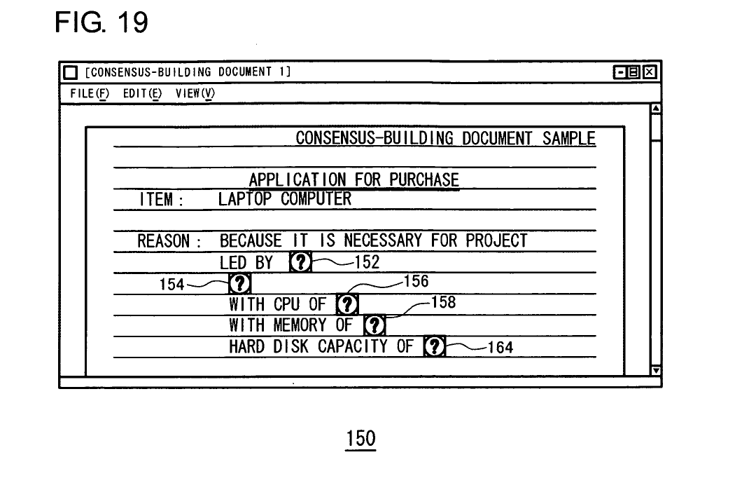

FIG. 19 shows a checking-mode source file 150 provided by displaying the checking-mode source file 140 shown in FIG. 18 in a format based upon a predetermined style sheet. In the checking-mode source file 140, the first level encryption region 112 has been decrypted. On the other hand, the second level encryption regions 116, 118, and 122, and the third level encryption region 124 have not been decrypted. Accordingly, the access to the contents is limited. That is to say, such regions, which have not been decrypted, are not disclosed to the consensus-building staff member A. A non-disclosure icon 152 corresponds to the third level encryption region 124. A non-disclosure icon 154 corresponds to the second level encryption region 114. A non-disclosure icon 156 corresponds to the second level encryption region 116. A non-disclosure icon 158 corresponds to the second level encryption region 118. A non-disclosure icon 164 corresponds to the second level encryption region 122.

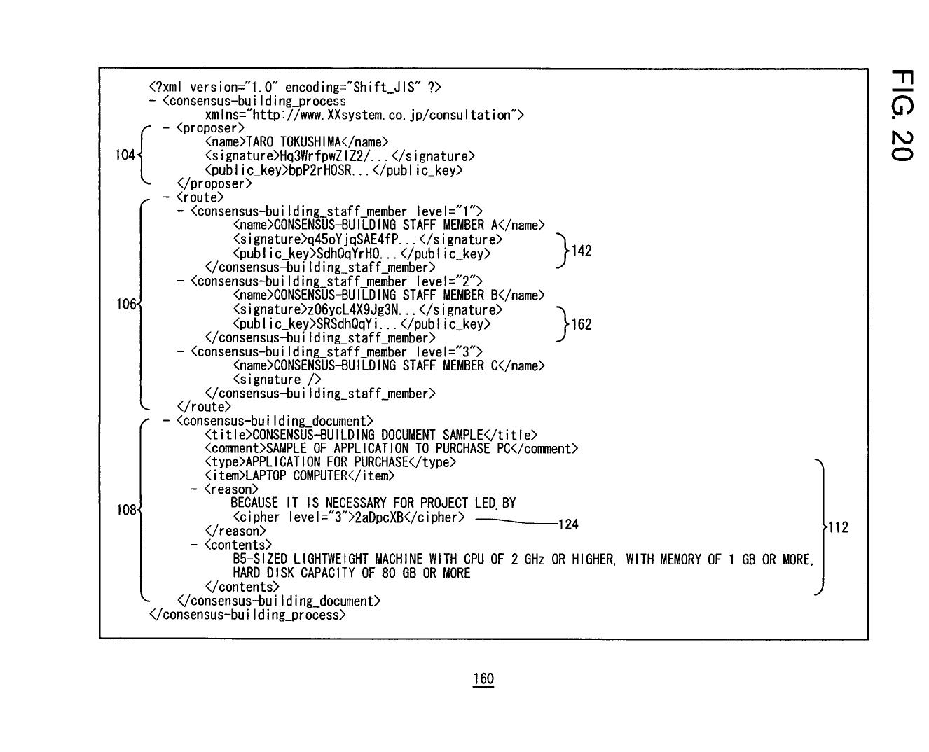

FIG. 20 shows a checking-mode source file 160 obtained by the consensus-building staff member B. Upon reception of the consensus-building document file, the document communication unit 306 adds the signature and the public key data of the consensus-building staff member B to a consensus-building staff member B signature region 162. The consensus-building staff member B is permitted to decrypt the data encrypted with the level 2. Accordingly, the data, which has been encrypted with the level 2, is additionally disclosed to the consensus-building staff member B. On the other hand, decryption of the third level encryption region 124 requires the access right of the access level 3. Accordingly, the third level encryption region 124 is not disclosed to the consensus-building staff member B.

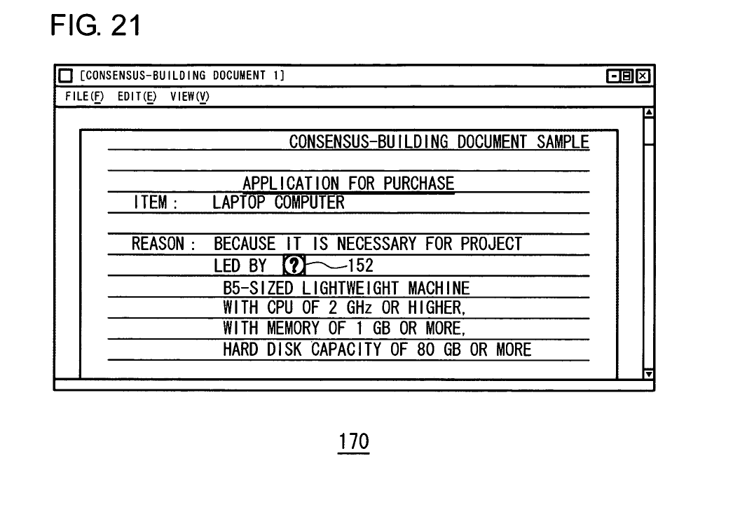

FIG. 21 shows a checking screen 170 on which the checking-mode source file 160 shown in FIG. 20 has been displayed in a format based upon a predetermined style sheet. On the checking screen 170, the third level encryption region 124 is not decrypted. That is to say, the access of this region is limited. Accordingly, the contents in the third level encryption region 124 are not disclosed to the consensus-building staff member B. The non-disclosure icon 152 corresponds to the third level encryption region 124.

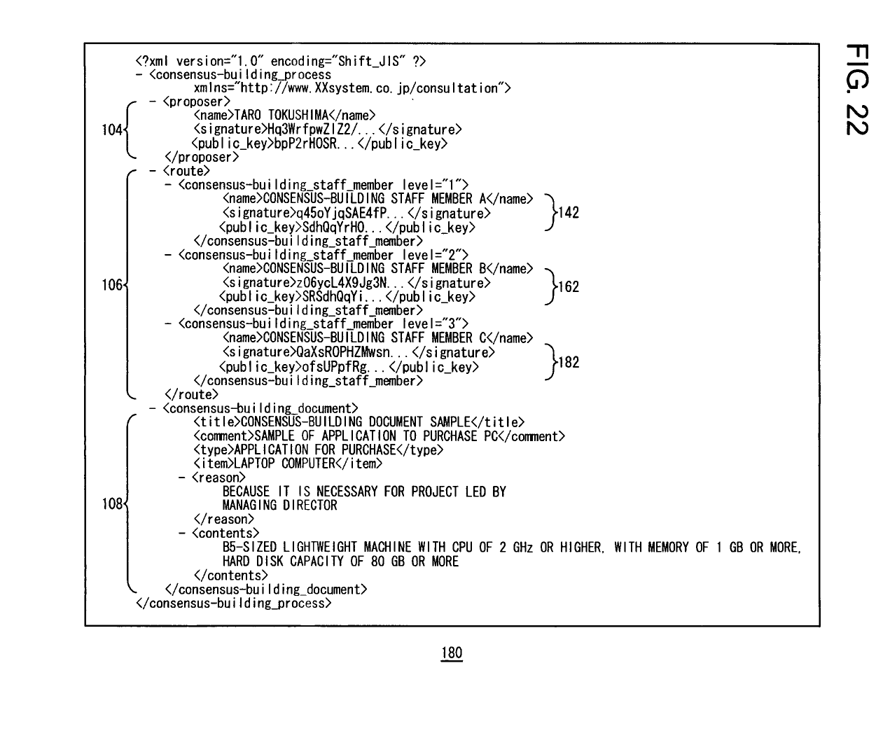

FIG. 22 shows a checking-mode source file 180 obtained by the consensus-building staff member C. Upon reception of the consensus-building document file, the document communication unit 306 adds the signature and the public key of the consensus-building staff member C to a consensus-building staff member C signature region 182. The consensus-building staff member C is permitted to decrypt the data encrypted with the level 3. Accordingly, the data, which has been encrypted with the level 3, is additionally disclosed to the consensus-building staff member C. Accordingly, the consensus-building document file is disclosed to the consensus-building staff member C without disclosure limitation.

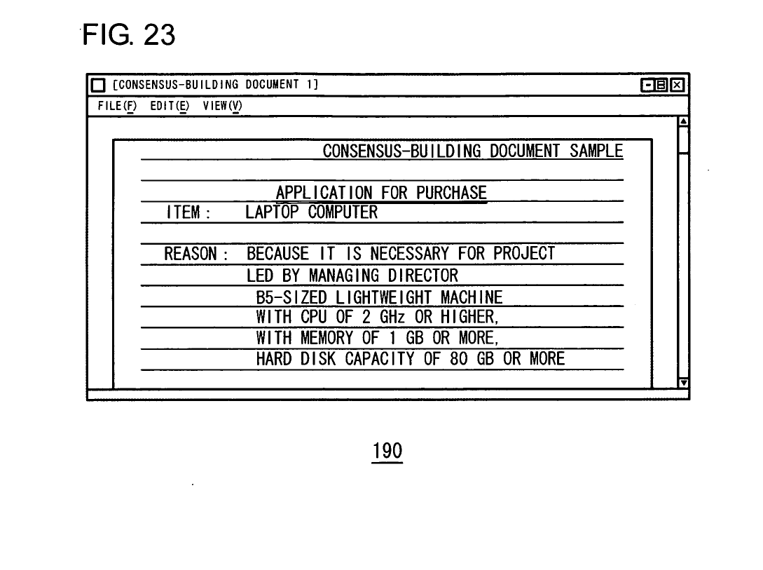

FIG. 23 shows a checking screen 190 on which the checking-mode source file 180 shown in FIG. 22 has been displayed in a format based upon a predetermined style sheet. The checking-mode source file 180 is provided without access limitation with respect to the contents. Accordingly, all the contents of the consensus-building document file are disclosed on the checking screen 190.

As described above, the access limitation of the encrypted consensus-building document file is relaxed in a multi-level manner during the processes of being circulated among the consensus-building staff members.

Next, description will be made with reference to flowcharts and so forth regarding the processing for encrypting a consensus-building document file and the processing for circulating the encrypted consensus-building document file.

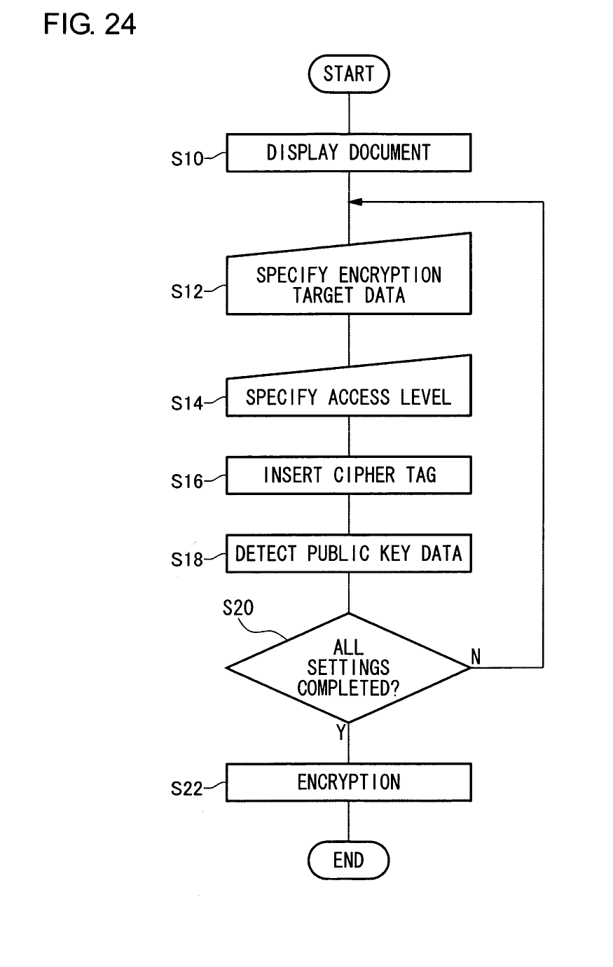

FIG. 24 is a flowchart which shows the process of the encryption processing for the consensus-building document file. First, the document display unit 210 acquires the consensus-building document file, which is a processing target, from the document storage unit 240, and displays the consensus-building document file on a screen (S10). Here, description will be made regarding an arrangement in which the consensus-building document file is displayed in a format based upon a predetermined style sheet as shown in FIG. 15. The proposer specifies the region of the data, which is to be encrypted, from the consensus-building document file thus displayed (S12). The proposer sets the access level for the encryption target data thus specified (S14).

The data extraction unit 230 creates a duplicate of the encryption target data thus specified, and transmits the duplicate to another region in the memory. Furthermore, the data extraction unit 230 inserts cipher tag into the consensus-building document file (S16). The key search unit 232 detects the public key data, which corresponds to the access level specified in S14, from the public key storage unit 242 (S18). Upon completion of settings for all the encryption target data by the user (in a case of “YES” in S20), the encryption processing unit 234 executes the encryption processing, thereby creating the encrypted consensus-building document file (S22). In a case that settings have not been completed (in a case of “NO” in S20), the flow returns to S12.

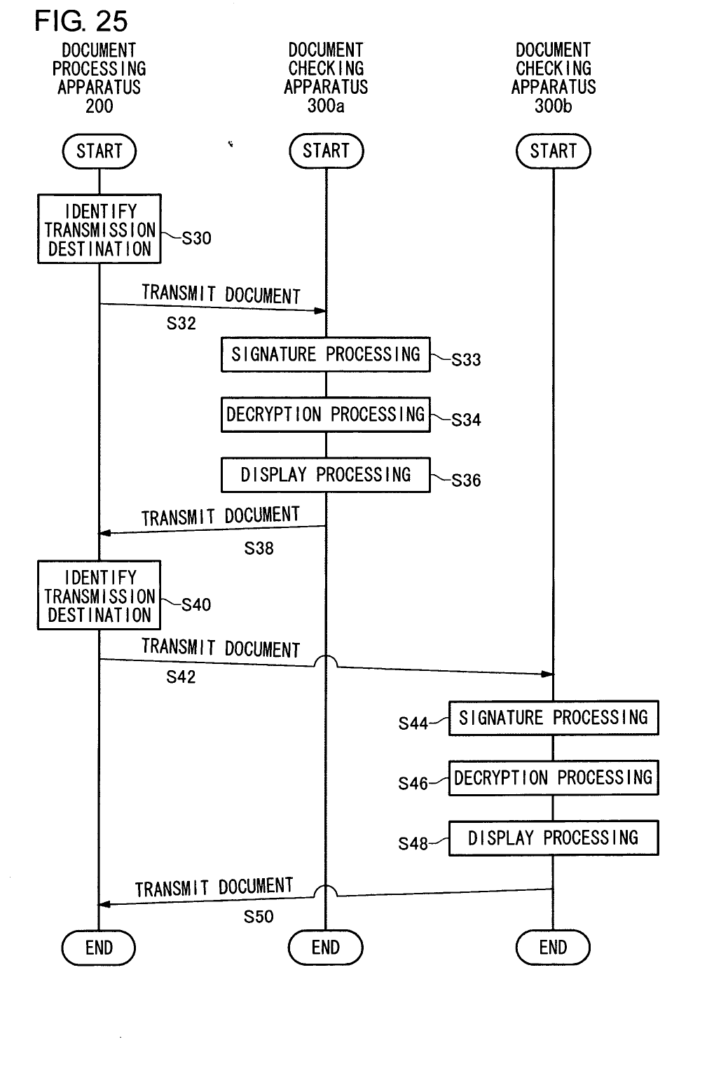

FIG. 25 shows a sequence diagram which shows a circulation process for a consensus-building document file. After the proposer has created the encrypted consensus-building document file, the proposer sets the circulation order information, which is used for circulating the consensus-building document file among the consensus-building staff members, via the circulation order setting unit 218. The circulation order information is stored in the circulation order storage unit 244. The circulation order setting unit 218 may directly add the circulation order thus set to the consensus-building document file. The transmission destination unit 244 identifies the transmission destination for the encrypted consensus-building document file thus created, with reference to the circulation order information (S30). The document communication unit 220 transmits the encrypted consensus-building document file to the document checking apparatus 300 specified by the transmission destination identifying unit 224 (S32). Here, the document checking apparatus 300a is selected as the transmission destination.

The document communication unit 306 of the document checking apparatus 300a receives the encrypted consensus-building document file. Upon reception of the encrypted consensus-building document file, the document communication unit 306 affixes a signature of the consensus-building staff member to the encrypted consensus-building document file (S33). The data extraction unit 320 detects the region in the consensus-building document file where data has been encrypted, based upon the cipher tags. The decryption processing unit 322 executes decryption processing using the private key data stored in the private key storage unit 332 (S34). The document display unit 310 displays the consensus-building document file thus decrypted on a screen (S36). The document communication unit 306 transmits the encrypted consensus-building document file thus checked to the document processing apparatus 200 (S38).

The document communication unit 220 receives the encrypted consensus-building document file transmitted from the document storage unit 330a. The transmission destination specifying unit 224 identifies the next destination with reference to the circulation order information (S40). The document communication unit 220 transmits the encrypted consensus-building document file to the document checking apparatus 300b specified by the transmission identifying unit 224 (S42). Upon reception of the encrypted consensus-building document file, the document communication unit 306 of the document checking apparatus 300b adds a signature of the consensus-building staff member to the consensus-building document file (S44). The decryption processing unit 322 decrypts the encrypted data in the encrypted consensus-building document file using the private key data (S46). The document display unit 310 displays the encrypted consensus-building document file thus decrypted on a screen (S48). The document communication unit 306 transmits the encrypted consensus-building document file thus checked to the document processing apparatus 200 (S50). The above-described processing is repeatedly performed, thereby executing circulation of the encrypted consensus-building document file according to the circulation order thus specified.

Another arrangement may be made in which the document processing apparatus 200 also transmits the circulation order information to the document checking apparatus 300a in S32. With such an arrangement, the document checking apparatus 300a identifies the document checking apparatus 300b, which is to be the next receiver of the encrypted consensus-building document file, with reference to the circulation order information. The document checking apparatus 300a transmits the encrypted consensus-building document file and the circulation order information to the document checking apparatus 300b after the display step (S36), instead of the document processing apparatus 200. Upon reception of the encrypted consensus-building document file and the circulation order information, the document processing apparatus 300b identifies the document checking apparatus 300c (not shown), which is to be the next receiver of the encrypted consensus-building document file, with reference to the circulation order information. As described above, with such an arrangement, multiple document checking apparatuses circulate a consensus-building document file according to the circulation order information.

Such an arrangement may allow the consensus-building staff member who is the user of the document checking apparatus 300 to input data which indicates that the consensus-building staff member has checked the contents of the consensus-building document file, or data which indicates that the consensus-building staff member has approved the contents, through the document checking apparatus 300. Then, the input processing unit 312 notifies the document communication unit 306 to the effect that such data has been input. Upon reception of such a notification, the document communication unit 306 transmits the confirmation information to the document processing apparatus 200. Such an arrangement allows the document managing apparatus to monitor the state of whether or not the consensus-building document has been checked, and the state of whether or not the consensus-building document file has been approved, in a real-time manner.

Description has been made regarding the present invention with reference to the embodiments. The present embodiment allows the proposer to encrypt a consensus-building document file only by specifying a region where the data is to be encrypted and the access level, via the user interface. Furthermore, the present embodiment provides automatic information disclosure to individual consensus-building staff members without troublesome operations via the user interface. Furthermore, with the present embodiment, the information is disclosed to the consensus-building staff members in a multi-level manner using the public key encryption method that provides high security, thereby enabling important information to be effectively managed. Furthermore, the present embodiment has the advantage of allowing the public key data to be replaced with almost no effect on the operations via the user interface. Furthermore, with the present embodiment, cipher tags are defined, whereby the present invention can be realized in a scheme of a markup language such as XML. This provides a system having high compatibility with existing systems.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

For example, description has been made in the present embodiment regarding an arrangement in which the key data is prepared for each access level, but rather, the key data may be prepared for each document checker. With such an arrangement, the proposer may set the access permission for each checker, instead of the access level.

Also, description has been made in the present embodiment regarding an arrangement in which each consensus-building staff member has the private key data that corresponds to the access level, e.g., an arrangement in which the consensus-building staff member A has the private key data with the access level 1, and the consensus-building staff member B has the private key data with the access level 2. Instead of such an arrangement, an arrangement may be made in which the consensus-building staff member B has two kinds of private key data, e.g., the private key data with the access level 1 and the private key data with the access level 2. Such an arrangement permits the consensus-building staff member B to check the data in a security range up to the access level 2 before it is checked by the consensus-building staff member A.

Also, an arrangement may be made which permits each document checker to encrypt the document file. For example, an arrangement may be made which permits the consensus-building staff member to add his/her own comment to the consensus-building document with access limitation.

Also, an arrangement may be made in which the public key encryption method is combined with other various authentication methods, e.g., knowledge-based authentication such as password authentication, biometrics authentication such as fingerprint authentication and iris authentication, etc., thereby providing improved security.

### INDUSTRIAL APPLICABILITY

The present invention provides an effective document file managing technique.

1. A document processing apparatus comprising:
a document storage unit for storing a document file which is to be encrypted;
a display processing unit for displaying the contents of the document file on a screen;
a region specifying input unit for allowing a document editor to specify the region of encryption target data in the document file displayed on the screen;
a public key storage unit for storing public key data that corresponds to private key data held by each document checker;
a checker specifying input unit for allowing the document editor to specify the document checkers who are to be permitted to access the encrypted target data;
a public key detection unit for detecting public key data that corresponds to the private key data of the document checkers thus specified;
an encryption processing unit for creating encrypted data by encrypting the encryption target data according to a public key encryption method using the public key data thus detected; and
an encrypted document creating unit for creating an encrypted document file by replacing the encryption target data thus specified in the document file with the encrypted data thus created.

2. A document processing apparatus according to claim 1, wherein, in a case that said region specifying input unit has not received the input data that allows the region of the encryption target data to be identified, said encryption processing unit sets the text data, which is the contents of the document file, to the encryption target data before it is encrypted.

3. A document processing apparatus according to claim 1, wherein the document file is a file described in a markup language,
and wherein said document processing apparatus further comprises:
a tag storage unit for storing cipher tags that allow the region of the encryption target data to be specified in the document file; and
a tag insertion unit having a function whereby, upon reception of the input that specifies the region of the encryption target data from said region specifying input unit, the cipher tag set is inserted before and after the region thus specified in the document file,
wherein said encryption processing unit identifies the region of the encryption target data by detecting the positions at which the cipher tag set has been inserted into the document file according to an instruction.

4. A document processing apparatus according to claim 1, further comprising:
an address storage unit for storing a communication address that allows each document checkers to be identified on a communication network;
a circulation order input unit which allows the document editor to specify a circulation order for circulating the document file among a plurality of document checkers;
a circulation order storage unit for storing the circulation order thus input in a recording medium;
a checker specifying unit for identifying the document checkers, who are to check the document file, with reference to the circulation order;
an address detection unit for detecting the communication address of each document checker thus detected;
a document transmission unit for transmitting the encrypted document file thus created to the communication address thus detected; and
a document receiving unit for receiving the encrypted document file from the document checker after it has been checked,
wherein, upon reception of the encrypted document file from the document checker after it has been checked, said checker identifying unit identifies the next document checker, who is to check the encrypted document file after it has been checked by the document checker, with reference to the circulation order.

5. A document processing apparatus according to claim 4, further comprising a checker ID insertion unit having a function whereby, upon reception of the encrypted document file from said document receiving unit, a checker ID is inserted into the encrypted document file for identifying the document checker who has checked the encrypted document file.

6. A document processing apparatus according to claim 1, further comprising:
an address storage unit for storing a communication address that allows each document checker to be identified on the communication network;
a circulation order input unit which allows the document editor to input data for specifying the circulation order for circulating the document file among a plurality of document checkers;
a circulation order storage unit for storing the circulation order thus input in a recording medium;
a checker identifying unit for identifying the first document checker, who is to check the document file in the first stage, with reference to the circulation order;
an address detection unit for detecting the communication address of the document checker thus specified; and
a document transmission unit for transmitting the order information that indicate the circulation order, as well as transmitting the encrypted document file thus created.

7. A document checking apparatus which has a communication address assigned corresponding to a document checker, and which is connected to the document processing apparatus according to claim 6 via a communication network, said document checking apparatus comprising:
a document file receiving unit for receiving the encrypted document file transmitted from said document processing apparatus;
a circulation order receiving unit for receiving the order information transmitted from said document processing apparatus;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next checker who is to check the document file in the nest stage with reference to the order information;
an address detection unit for detecting the communication address of the document checker thus identified; and
a document transmission unit for transmitting the encrypted document file thus decrypted to the communication address thus identified, as well as transmitting the order information.

8. A document checking apparatus which has a communication address assigned corresponding to a document checker, and which is connected to the document checking apparatus according to claim 7 via a communication network, said document checking apparatus comprising:
a document file receiving unit for receiving the encrypted document file transmitted from the document checking apparatus according to claim 7;
a circulation order receiving unit for receiving the order information transmitted from the document checking apparatus according to claim 7;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next document checker, who is to check the document file in the nest stage, with reference to the order information;
an address detection unit for detecting the communication address of the document checker thus identified; and
a document transmission unit for transmitting the encrypted document file thus decrypted to the communication address thus detected.

9. A document checking apparatus according to claim 8, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

10. A document processing method comprising:
a step for displaying the contents of a document file, which is to be encrypted, on a screen;
a step for allowing a document editor to input data that specifies the region of encryption target data in the document file displayed on the screen;
a step for allowing the document editor to input data that specifies document checkers who are to check the encryption target data;
a step for detecting public key data that corresponds to private key data of each document checker thus specified by searching a recording medium that stores public key data that corresponds to the private key data held by the document checkers;
a step for creating encrypted data by encrypting the encryption target data according to a public key encryption method using the public key data thus detected; and
a step for creating an encrypted document file by replacing the encryption target data specified in the document file with the encrypted data thus created.

11. A document processing program that instructs a computer to provide:
a function of storing a document file which is to be encrypted;
a function of displaying the contents of the document file on a screen;
a function of allowing a document editor to input data that specifies the region of encryption target data in the document file thus displayed on the screen;
a function of storing private key data that corresponds to private key data held by document checkers;
a function of allowing the document editor to input data that specifies the document checkers who are to check the encrypted target data;
a function of detecting the public key data that corresponds to the private key data of each document checker thus specified;
a function of creating encrypted data by encrypting the encryption target data according to a public key encryption method using the public key data thus detected; and
a function of creating an encrypted document file by replacing the encryption target data specified in the document file with the encrypted data thus created.

12. A document processing apparatus according to claim 2, wherein the document file is a file described in a markup language,
and wherein said document processing apparatus further comprises:
a tag storage unit for storing cipher tags that allow the region of the encryption target data to be specified in the document file; and
a tag insertion unit having a function whereby, upon reception of the input that specifies the region of the encryption target data from said region specifying input unit, the cipher tag set is inserted before and after the region thus specified in the document file,
wherein said encryption processing unit identifies the region of the encryption target data by detecting the positions at which the cipher tag set has been inserted into the document file according to an instruction.

13. A document processing apparatus according to claim 2, further comprising:
an address storage unit for storing a communication address that allows each document checkers to be identified on a communication network;
a circulation order input unit which allows the document editor to specify a circulation order for circulating the document file among a plurality of document checkers;
a circulation order storage unit for storing the circulation order thus input in a recording medium;
a checker specifying unit for identifying the document checkers, who are to check the document file, with reference to the circulation order;
an address detection unit for detecting the communication address of each document checker thus detected;
a document transmission unit for transmitting the encrypted document file thus created to the communication address thus detected; and
a document receiving unit for receiving the encrypted document file from the document checker after it has been checked,
wherein, upon reception of the encrypted document file from the document checker after it has been checked, said checker identifying unit identifies the next document checker, who is to check the encrypted document file after it has been checked by the document checker, with reference to the circulation order.

14. A document processing apparatus according to claim 3, further comprising:
an address storage unit for storing a communication address that allows each document checkers to be identified on a communication network;
a circulation order input unit which allows the document editor to specify a circulation order for circulating the document file among a plurality of document checkers;
a circulation order storage unit for storing the circulation order thus input in a recording medium;
a checker specifying unit for identifying the document checkers, who are to check the document file, with reference to the circulation order;
an address detection unit for detecting the communication address of each document checker thus detected;
a document transmission unit for transmitting the encrypted document file thus created to the communication address thus detected; and
a document receiving unit for receiving the encrypted document file from the document checker after it has been checked,
wherein, upon reception of the encrypted document file from the document checker after it has been checked, said checker identifying unit identifies the next document checker, who is to check the encrypted document file after it has been checked by the document checker, with reference to the circulation order.

15. A document processing apparatus according to claim 12, further comprising:
an address storage unit for storing a communication address that allows each document checkers to be identified on a communication network;
a circulation order input unit which allows the document editor to specify a circulation order for circulating the document file among a plurality of document checkers;
a circulation order storage unit for storing the circulation order thus input in a recording medium;
a checker specifying unit for identifying the document checkers, who are to check the document file, with reference to the circulation order;
an address detection unit for detecting the communication address of each document checker thus detected;
a document transmission unit for transmitting the encrypted document file thus created to the communication address thus detected; and
a document receiving unit for receiving the encrypted document file from the document checker after it has been checked,
wherein, upon reception of the encrypted document file from the document checker after it has been checked, said checker identifying unit identifies the next document checker, who is to check the encrypted document file after it has been checked by the document checker, with reference to the circulation order.

16. A document processing apparatus according to claim 13, further comprising a checker ID insertion unit having a function whereby, upon reception of the encrypted document file from said document receiving unit, a checker ID is inserted into the encrypted document file for identifying the document checker who has checked the encrypted document file.

17. A document processing apparatus according to claim 14, further comprising a checker ID insertion unit having a function whereby, upon reception of the encrypted document file from said document receiving unit, a checker ID is inserted into the encrypted document file for identifying the document checker who has checked the encrypted document file.

18. A document processing apparatus according to claim 15, further comprising a checker ID insertion unit having a function whereby, upon reception of the encrypted document file from said document receiving unit, a checker ID is inserted into the encrypted document file for identifying the document checker who has checked the encrypted document file.

19. A document processing apparatus according to claim 2, further comprising:
an address storage unit for storing a communication address that allows each document checker to be identified on the communication network;
a circulation order input unit which allows the document editor to input data for specifying the circulation order for circulating the document file among a plurality of document checkers;
a circulation order storage unit for storing the circulation order thus input in a recording medium;
a checker identifying unit for identifying the first document checker, who is to check the document file in the first stage, with reference to the circulation order;
an address detection unit for detecting the communication address of the document checker thus specified; and
a document transmission unit for transmitting the order information that indicate the circulation order, as well as transmitting the encrypted document file thus created.

20. A document processing apparatus according to claim 3, further comprising:
an address storage unit for storing a communication address that allows each document checker to be identified on the communication network;
a circulation order input unit which allows the document editor to input data for specifying the circulation order for circulating the document file among a plurality of document checkers;
a circulation order storage unit for storing the circulation order thus input in a recording medium;
a checker identifying unit for identifying the first document checker, who is to check the document file in the first stage, with reference to the circulation order;
an address detection unit for detecting the communication address of the document checker thus specified; and
a document transmission unit for transmitting the order information that indicate the circulation order, as well as transmitting the encrypted document file thus created.

21. A document processing apparatus according to claim 12, further comprising:
an address storage unit for storing a communication address that allows each document checker to be identified on the communication network;
a circulation order input unit which allows the document editor to input data for specifying the circulation order for circulating the document file among a plurality of document checkers;
a circulation order storage unit for storing the circulation order thus input in a recording medium;
a checker identifying unit for identifying the first document checker, who is to check the document file in the first stage, with reference to the circulation order;
an address detection unit for detecting the communication address of the document checker thus specified; and
a document transmission unit for transmitting the order information that indicate the circulation order, as well as transmitting the encrypted document file thus created.

22. A document checking apparatus which has a communication address assigned corresponding to a document checker, and which is connected to the document processing apparatus according to claim 19 via a communication network, said document checking apparatus comprising:
a document file receiving unit for receiving the encrypted document file transmitted from said document processing apparatus;
a circulation order receiving unit for receiving the order information transmitted from said document processing apparatus;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next checker who is to check the document file in the nest stage with reference to the order information;
an address detection unit for detecting the communication address of the document checker thus identified; and
a document transmission unit for transmitting the encrypted document file thus decrypted to the communication address thus identified, as well as transmitting the order information.

23. A document checking apparatus which has a communication address assigned corresponding to a document checker, and which is connected to the document processing apparatus according to claim 20 via a communication network, said document checking apparatus comprising:
a document file receiving unit for receiving the encrypted document file transmitted from said document processing apparatus;
a circulation order receiving unit for receiving the order information transmitted from said document processing apparatus;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next checker who is to check the document file in the nest stage with reference to the order information;
an address detection unit for detecting the communication address of the document checker thus identified; and
a document transmission unit for transmitting the encrypted document file thus decrypted to the communication address thus identified, as well as transmitting the order information.

24. A document checking apparatus which has a communication address assigned corresponding to a document checker, and which is connected to the document processing apparatus according to claim 21 via a communication network, said document checking apparatus comprising:
a document file receiving unit for receiving the encrypted document file transmitted from said document processing apparatus;
a circulation order receiving unit for receiving the order information transmitted from said document processing apparatus;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next checker who is to check the document file in the nest stage with reference to the order information;
an address detection unit for detecting the communication address of the document checker thus identified; and
a document transmission unit for transmitting the encrypted document file thus decrypted to the communication address thus identified, as well as transmitting the order information.

25. A document checking apparatus which has a communication address assigned corresponding to a document checker, and which is connected to the document checking apparatus according to claim 22 via a communication network, said document checking apparatus comprising:
a document file receiving unit for receiving the encrypted document file transmitted from the document checking apparatus according to claim 22;
a circulation order receiving unit for receiving the order information transmitted from the document processing apparatus;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next document checker, who is to check the document file in the nest stage, with reference to the order information;
an address detection unit for detecting the communication address of the document checker thus identified; and
a document transmission unit for transmitting the encrypted document file thus decrypted to the communication address thus detected.

26. A document checking apparatus which has a communication address assigned corresponding to a document checker, and which is connected to the document checking apparatus according to claim 23 via a communication network, said document checking apparatus comprising:
a document file receiving unit for receiving the encrypted document file transmitted from the document checking apparatus according to claim 23;
a circulation order receiving unit for receiving the order information transmitted from the document checking apparatus according to claim 23;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next document checker, who is to check the document file in the nest stage, with reference to the order information;
an address detection unit for detecting the communication address of the document checker thus identified; and
a document transmission unit for transmitting the encrypted document file thus decrypted to the communication address thus detected.

27. A document checking apparatus which has a communication address assigned corresponding to a document checker, and which is connected to the document checking apparatus according to claim 24 via a communication network, said document checking apparatus comprising:
a document file receiving unit for receiving the encrypted document file transmitted from the document checking apparatus according to claim 24;
a circulation order receiving unit for receiving the order information transmitted from the document checking apparatus according to claim 24;
a private key storage unit for storing private key data;
a decryption processing unit for decrypting at least a part of the encrypted document file using the private key data;
an address storage unit for storing the communication address that allows each document checker to be identified on the communication network;
a checker identifying unit for identifying the next document checker, who is to check the document file in the nest stage, with reference to the order information;
an address detection unit for detecting the communication address of the document checker thus identified; and
a document transmission unit for transmitting the encrypted document file thus decrypted to the communication address thus detected.

28. A document checking apparatus according to claim 22, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

29. A document checking apparatus according to claim 23, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

30. A document checking apparatus according to claim 24, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

31. A document checking apparatus according to claim 25, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus. a check information transmission unit having a function whereby, upon reception of the input data that indicates that check has been made, check information, which indicates that the contents of the encrypted document file has been checked, is transmitted to the document checking apparatus.

32. A document checking apparatus according to claim 26, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

33. A document checking apparatus according to claim 27, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.

34. A document checking apparatus according to claim 28, further comprising:
a document display unit for displaying the contents of the encrypted document file on a screen after it has been decrypted;
a check information input unit that allows the document checker to input data which indicates that the document checker has checked the contents of the encrypted document file; and
a check information transmission unit having a function whereby, upon reception of the input data that indicates that check has been made, check information, which indicates that the contents of the encrypted document file has been checked, is transmitted to the document checking apparatus.
